(19) United States
(12) Patent Application Publication
(10) Pub. No.: US 2013/0312044 A1
(43) Pub. Date: Nov. 21, 2013

(54) NETWORK TERMINAL SYSTEM AND WIRELESS TERMINAL

(71) Applicant: Hitachi Consumer Electronics Co., Ltd., Tokyo (JP)

(72) Inventor: Tsuguo ITAGAKI, Yokohama-shi (JP)

(73) Assignee: Hitachi Consumer Electronics Co., Ltd., Tokyo (JP)

(21) Appl. No.: 13/890,564

(22) Filed: May 9, 2013

(30) Foreign Application Priority Data
May 17, 2012 (JP) 2012-113192

(51) Int. Cl. H04N 21/61

(52) U.S. Cl. CPC H04N 21/6131
USPC 725/62

(57) ABSTRACT

A network terminal system connects a wireless terminal and a display device with a network. The wireless terminal obtains contents, an identifier that contains information indicating a server for supplying the contents and information for identifying the contents, and session information for uniquely identifying a user of the wireless terminal, from an external network. The obtained identifier and the session information are transmitted to the display device. The display device obtains the contents and the session information correlated with the contents from the server indicated by the identifier transmitted from the wireless terminal, and displays the obtained contents on the display unit.

### CLAIM OF PRIORITY

The present application claims priority from Japanese patent application serial no. JP 2012-113192, filed on May 17, 2012, the content of which is hereby incorporated by reference into this application.

### BACKGROUND OF THE INVENTION

(1) Field of the Invention

The present invention relates to a network terminal system and a wireless terminal.

(2) Description of the Related Art

Recently, the TV receiver with Internet access function (network TV) has been familiarized to enable viewing of the video program distributed on Internet. Japanese Patent Application Laid-Open Publication No. 2009-258963 as related art discloses the technology aiming at providing the user with pages with excellent visibility displayed on the screen of the information electric appliance (network terminal) by enabling the layout of the page to be correlated with the aspect ratio of the screen. The technology includes steps of allowing the server to produce the page corresponding to the display area of the network terminal in response to the page transmission request requiring the page to be displayed on the screen display unit of the network terminal, and of transmitting the produced page to the network terminal so that the produced page is formed in the format of at least two columns on the display area.

### SUMMARY OF THE INVENTION

Japanese Patent Application Laid-Open Publication No. 2009-258963 discloses a system configured to perform layout analysis with respect to Web page in an HTML format by the server, and to produce screen display data including advertisements for transmission of the laid out Web page to the information electric appliance that displays such Web page. However, the method as disclosed in the related art requires a server to execute the layout. It is difficult for such method to allow the user to simultaneously browse the contents transmitted from the server on two network terminals each having a different format for displaying contents. For example, the web site or Internet publication of video contents which have been currently displayed and reproduced on the mobile terminal (wireless terminal) cannot be appropriately displayed through scaling up of such contents on the network TV (display device) with a large-sized screen. This is because the mobile terminal is compliant with the Web page that has not been laid out, and the network TV is compliant with the laid out Web page.

The present invention provides a network terminal system and a wireless terminal which enable the contents currently browsed on the wireless terminal to be easily displayed on the display device with the different display format.

The present invention provides a network terminal system that allows a wireless terminal and a display device, which are connected via a network to obtain contents from a server via an external network. The wireless terminal includes a first information obtaining unit that obtains first contents, an identifier that contains information indicating a server for supplying the first contents and information for identifying the first contents, and session information for uniquely identifying a user of the wireless terminal, from the external network, and a first transmitter/receiver unit which transmits the identifier and the session information obtained by the first information obtaining unit to the display device. The display device includes a second transmitter/receiver unit that receives the identifier and the session information transmitted from the wireless terminal, a second information obtaining unit that obtains the first contents and the session information correlated with the first contents from the server indicated by the identifier received by the second transmitter/receiver unit, and a second display unit that displays the first contents obtained by the second information obtaining unit.

The present invention allows the contents displayed on the wireless terminal to be easily displayed on the display device with the different display format, resulting in improved convenience for the user. Any other problem, structure and advantage other than those described above will be clarified by the following descriptions.

### BRIEF DESCRIPTION OF THE DRAWINGS

FIG. 1 is a block diagram representing a network terminal system according to a first embodiment;

FIG. 2A shows an inner structure of a TV receiver 1;

FIG. 2B shows an inner structure of a wireless terminal 3;

FIG. 3A shows structures of a memory 25 and a storage 26 within the TV receiver 1;

FIG. 3B shows structures of a memory 33 and a storage 34 within the wireless terminal 3;

FIG. 4A shows a data format of display position information transmitted from the wireless terminal 3 to the TV receiver 1;

FIG. 4B illustrates a positional relationship between a display area and Web contents on the wireless terminal 3;

FIG. 5 shows an operating sequence according to the embodiment;

FIG. 6A illustrates a display screen and operation of the wireless terminal 3;

FIG. 6B illustrates the display screen and operation of the wireless terminal 3;

FIG. 6C illustrates the display screen and operation of the wireless terminal 3;

FIG. 7A illustrates a display screen of the TV receiver 1;

FIG. 7B illustrates the display screen of the TV receiver 1;

FIG. 7C illustrates the display screen of the TV receiver 1;

FIG. 8A shows structures of the memory 25 and the storage 26 within the TV receiver 1 according to a second embodiment;

FIG. 8B shows structures of the memory 33 and the storage 34 within the wireless terminal 3 according to the second embodiment;

FIG. 9 shows an operating sequence according to the second embodiment;

FIG. 10A illustrates the display screen and operation of the wireless terminal 3;

FIG. 10B illustrates the display screen and operation of the wireless terminal 3;

FIG. 11 shows an operating sequence according to a third embodiment;

FIG. 12 illustrates the display screen and operation of the wireless terminal 3;

FIG. 13A illustrates the display screen of the TV receiver 1;

FIG. 13B illustrates the display screen of the TV receiver 1;

FIG. 14 shows an operating sequence according to a fourth embodiment;

FIG. 15 illustrates the display screen and operation of the wireless terminal 3 according to a fifth embodiment;

FIG. 16 shows an operating sequence according to a sixth embodiment;

FIG. 17 illustrates the display screen and operation of the wireless terminal 3;

FIG. 18A shows structures of the memory 25 and the storage 26 within the TV receiver 1 according to a seventh embodiment;

FIG. 18B shows structures of the memory 33 and the storage 34 within the wireless terminal 3 according to the seventh embodiment;

FIG. 19 shows an operating sequence according to the seventh embodiment;

FIG. 20A illustrates the display screen of the TV receiver 1;

FIG. 20B illustrates the display screen and operation of the wireless terminal 3;

FIG. 20C illustrates the display screen and operation of the wireless terminal 3; and

FIG. 20D illustrates the display screen of the TV receiver 1.

### DETAILED DESCRIPTION OF THE EMBODIMENT

The embodiment as described below is exemplified by a network terminal system including the TV receiver accessible to Internet (which may be referred to as a display device), and the wireless device (or so called wireless terminal), for example, a mobile terminal. The TV receiver has functions of receiving digital broadcasting signal that contains service information (event information), and displaying the electronic program guide (EPG) for digital broadcasting in Japan based on the received service information. The program information of the digital broadcasting will be briefly described hereinafter.

BS digital broadcasting, CS digital broadcasting, and digital terrestrial broadcasting have transferred signals by multiplexing a plurality of transport streams (hereinafter referred to as “TS”) with the single transponder (frequency channel).

The TS has the data structure compliant with Standards of Association of Radio Industries and Business of Japan (ARIB), and is formed of TS packet obtained by adding the service information as the event information, which is functioning as the header to element signals (ES: Elementary Stream) as contents data. The data structure of the service information is in accordance with ARIB STD-B10 “Standards of Service Information for Digital Broadcasting System” as ARIB Standard. The service information is formed of PSI (Program Specific Information) as the transfer control information specified in MPEG (Moving Picture Expert Group)-2-system Standard, and SI (Service Information) for establishment of EPG and the like.

The SI includes four tables, that is, BIT (Broadcaster Information Table), SDT (Service Description Table), EIT (Event Information Table), and TOT (Time Offset Table).

The BIT describes the information relevant to the broadcasting station in the network. The SDT is separated into a TS information section and a service information section. The TS information section contains network IDs for identifying the network, and TS IDs (Identifiers) for identifying the TS. Different network IDs are allocated to the BS network, CS1 network and CS2 network, respectively. As for the digital terrestrial broadcasting, the network IDs with different values are allocated to the respective broadcasting stations in the same region. The service information section contains service IDs (so called channel numbers) as identifiers for identifying the respective services (channels) in the network.

The EIT describes the service information for each event (so called program), and is separated into the service information section and the event information section. The service information section contains the service IDs (so called channel numbers) as the identifiers for identifying the respective services (channels) in the network. The event information section contains event IDs, event start time, event duration time, title of the event (so called program title), and the event genre. The TOT describes the current time.

The digital broadcasting distributed in Japan has been described so far. However, the similar program information to the above-described service information has been transferred by the digital broadcasting in the respective countries. Accordingly, embodiments to be described below are applicable to the digital broadcasting in other countries.

### First Embodiment

A first embodiment according to the present invention will be described. The first embodiment is configured to display Web contents displayed on the wireless terminal on the TV receiver with the different display format by using the display position information (hereinafter referred to as the position information) without missing any part of the screen.

### <System Structure>

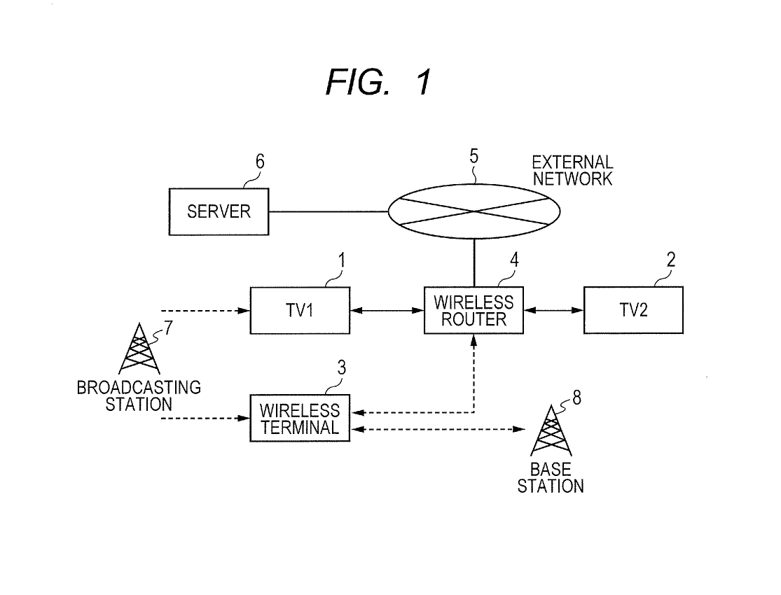

FIG. 1 is a block diagram illustrating the network terminal system according to the first embodiment. The network terminal system of the embodiment is configured to have a first TV receiver (display device) 1 and a second TV receiver (display device) 2, and a wireless terminal 3 connected to an external network 5 such as Internet via a wireless router 4. The first and the second TV receivers 1 and 2, and the wireless terminal 3 receive the digital broadcasting from a broadcasting station 7. The wireless terminal 3 is allowed to communicate with a base station 8. An example shown in FIG. 1 is made on the assumption that the user who carries the wireless terminal 3 as the mobile communication terminal, for example the mobile phone, is viewing video contents displayed on the TV receiver 1 at home, store or the like.

The wireless router 4 has a wireless LAN function such as Wi-Fi, and is accessible to the external network 5 via the communication line. The wireless router 4 is connected to the TV receivers 1 and 2 via the wired LAN or the wireless LAN, and is connected to the wireless terminal 3 via the wireless LAN. The “Wi-Fi” is Standard of the wireless LAN (Local Area Network) specified in Standards “IEEE 802.11a/IEEE 802.11b” of Institute of Electrical and Electronics Engineers (IEEE). This allows the TV receivers 1 and 2, and the wireless terminal 3 to obtain such information as the video contents from a server 6 connected to the external network 5.

### <TV Receiver>

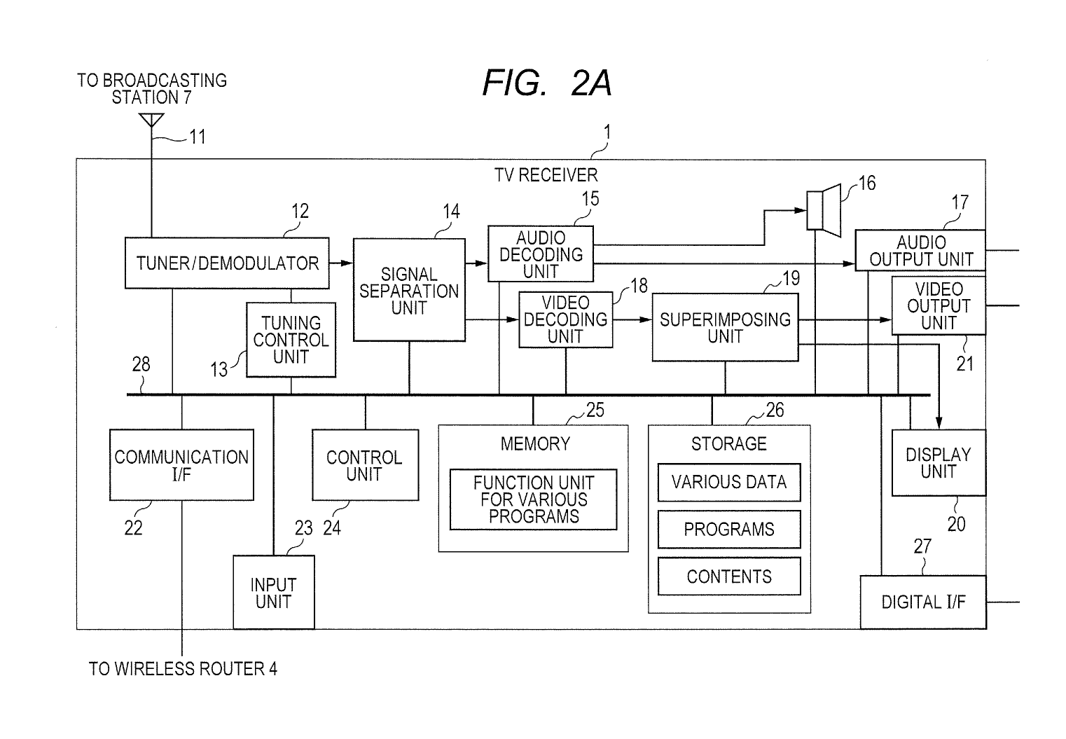

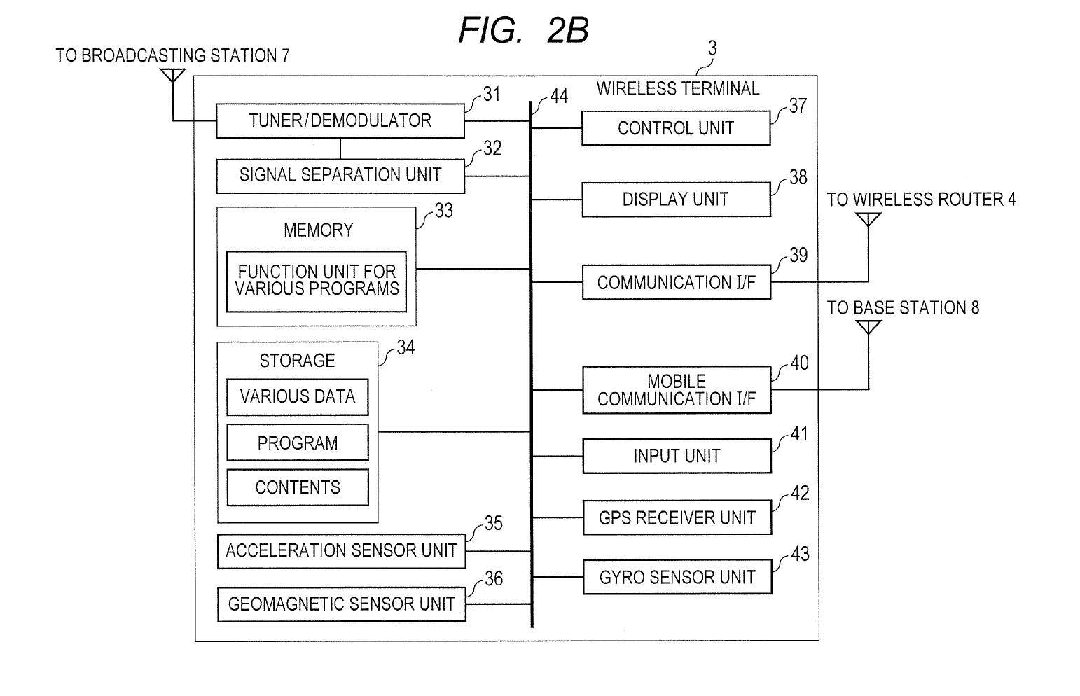

FIG. 2A is a block diagram illustrating an inner structure of the TV receiver 1. The structure applies to the TV receiver 2. The TV receiver 1 connected to an antenna 11 includes a tuner/demodulator 12, a tuning control unit 13, a signal separation unit 14, an audio decoding unit 15, a speaker 16, an audio output unit 17, a video decoding unit 18, a superimposing unit 19, a display unit 20, a video output unit 21, a communication I/F 22, an input unit 23, a control unit 24, a memory 25, a storage 26, and a digital I/F 27. The respective processing units are connected via a bus 28 with one another.

Various operation functions of the TV receiver 1 are realized by application program stored in the storage 26. The control unit 24 loads the program in the memory 25 from the storage 26 and executes the program so as to realize various functions. For simplification, it is assumed that various functions to be realized through execution of the respective programs by the control unit 24 will be provided mainly by the “function unit for various programs” loaded in the memory 25.

The application program may be preliminarily stored in the storage 26 at the time of shipment of the TV receiver 1. Alternatively, the program may be stored in such medium as the optical medium, for example, CD and DVD, and semiconductor memory, so as to be installed in the TV receiver 1 via a not shown medium connector part. It may also be downloaded from the external network 5 via the communication I/F 22 and the wireless router 4 for installation. The various functions realized by the application program may also be realized by hardware as the processing unit with the same function. If the program is realized by the hardware, the respective processing units are executed to perform functions independently.

The input unit 23 as the input device receives an input operation of the user to the TV receiver 1, for example, a remote control, a keyboard, a pointing device such as a mouse. The control unit 24 receives the input operation of the users via the input unit 23, and controls the respective processing units of the tuning control unit 13, the signal separation unit 14, the superimposing unit 19, the memory 25 (function unit for various programs), the storage 26, and the communication I/F 22.

The tuner/demodulator 12 is controlled by the tuning control unit 13 so as to be synchronized with the channel of the desired service. The desired digital broadcasting signal received from the broadcasting station 7 via the antenna 11 is selected and the broadcasting signal is demodulated for producing the transport stream. The tuning control unit 13 controls the tuner/demodulator 12 for switching the selector channel in response to the instruction to tune the service via the input unit 23. The tuning control unit 13 controls the tuner/demodulator 12 to switch the service (channel number) that broadcasts the event on the air, and the broadcasting distribution unit to which the service belongs in response to the instruction from the function unit for various programs.

The communication I/F 22 is connected to the wireless router 4 through the wired LAN or the wireless LAN. Various types of information will be received and transmitted between the communication I/F 22, and the other TV receiver 2 and the wireless terminal 3 via the wireless router 4. The communication I/F 22 is capable of transmitting and receiving various types of information to and from the device connected to the external network 5 via the wireless router 4. For example, it is capable of receiving the contents stream (video audio stream) through the IP broadcasting or video-on-demand format from the server 6 connected to the external network 5. It is also possible to download the video stream and the application program from the server 6 connected to the external network 5. The downloaded information will be stored in the storage 26, for example.

The signal separation unit 14 separates the transport stream derived from the tuner/demodulator 12, and the stream of the contents obtained via the communication I/F 22 into such data as video data, audio data, caption data, and program information data for each type. The unit includes the function of obtaining the program information (for example, service information SI) so as to be transmitted to the other processing unit. In response to reception of the data transmission request from the other processing unit, the unit transmits the designated data to the requestor.

The audio decoding unit 15 decodes the audio data separated by the signal separation unit 14. The audio information decoded by the audio decoding unit 15 will be output from the speaker 16. The audio information decoded by the audio decoding unit 15 may be output to the external equipment from the audio output unit 17. The video decoding unit 18 decodes the video data separated by the signal separation unit 14. The video information decoded by the video decoding unit 18 is transmitted to the superimposing unit 19.

The superimposing unit 19 superimposes the EPG image data produced by the function unit for various programs, the OSD image data, and images derived from various types of information (caption information, subtitles, data broadcasting data and the like) separated by the signal separation unit 14 on the decoded video information transmitted from the video decoding unit 18. The superimposing unit 19 synthesizes the browser display screen produced by a browser engine 2101 (described later) and the video signals, or selectively switches therebetween. The video information via the superimposing unit 19 is displayed on the display unit 20.

The display unit 20 is formed of a display or a liquid crystal panel for the TV and personal computer, for example for displaying the broadcasted/distributed video images, UI for various operations, Web browser, and images stored in the storage 26. The video information via the superimposing unit 19 may be output to the external equipment from the video output unit 21. The digital I/F 27 may be provided to allow the signal separation unit 14 to separate the transport stream with respect to the predetermined program for outputting video and audio data without decoding.

The storage 26 stores the application program and various types of information produced by the application program, and is capable of storing the contents such as the video audio stream from the signal received by the tuner/demodulator 12 and the communication I/F 22. The function parts of the application program stored in the storage 26 are loaded in the memory 25 under the control of the control unit 24.

The display unit 20 is capable of displaying various types of image and video data, for example, the image produced by the application program, image and video data of the contents received via the tuner/demodulator 12, those received from the server 6 on the external network 5 via the communication I/F 22, and those received from the wireless terminal 3 via the communication I/F 22.

Structures of the respective units of the TV receiver 2 are the same as those of the TV receiver 1, and descriptions thereof, thus will be omitted. In this embodiment, use of the TV receiver is described. However, STB (Set Top Box) and the recorder having the display unit and the speaker connected to the outside may be used.

### <Wireless Terminal>

FIG. 2B illustrates an inner structure of the wireless terminal 3. The wireless terminal 3 includes a tuner/demodulator 31, a signal separation unit 32, a memory 33, a storage 34, an acceleration sensor unit 35, a geomagnetic sensor unit 36, a control unit 37, a display unit 38, a communication I/F 39, a mobile communication I/F 40, an input unit 41, a GPS receiver unit 42, and a gyro sensor unit 43. The respective processing units are connected with one another via a bus 44.

The wireless terminal 3 stores the application program in the storage 34 from which the control unit 37 loads the program into the memory 33. The control unit 37 executes the program to realize the respective functions. The description below will be explained for simplification on the assumption that the respective functions to be realized through execution of the application programs by the control unit 37 are established by “function unit for various programs”, which has been loaded in the memory 33.

The application program may be preliminarily stored at the time of shipment of the wireless terminal 3. Alternatively, it may be stored in the medium, for example, the optical medium such as CD and DVD, and the semiconductor memory so as to be installed in the wireless terminal 3 via a not shown medium connector part. It may be downloaded from the external network 5 via the communication I/F 39 and the wireless router 4 for installation. It may further be downloaded from the base station 8 (distributor) via the mobile communication I/F 40 for installation. Various functions realized by the application program may also be realized by hardware as the processing unit with the same functions. If they are realized by the hardware, the respective processing units perform functions independently.

The tuner/demodulator 31 and the signal separation unit 32 are operated in the same way as the tuner/demodulator 12 and the signal separation unit 14 of the TV receiver 1 as shown in FIG. 2A.

Various types of information is transmitted and received between the communication I/F 39 and the communication I/F 22 of the TV receiver 1 via the wireless router 4. The communication I/F 39 is connected to the external network 5 via the wireless router 4 so as to transmit and receive the information to and from the server 6 and the like on the external network 5. The mobile communication I/F 40 is connected to the communication network via the base station 8, and capable of transmitting and receiving the information to and from the server on the communication network.

The control unit 37 receives the input operation of the user via the input unit 41, and controls the signal separation unit 32, the memory 33 (function unit for various programs), the display unit 38, and the communication I/F 39. The control unit 37 has the function of obtaining the program information and the service information from the external network 5 via the communication I/F 39 and the wireless router 4, or from the communication network via the mobile communication I/F 40 and the base station 8, and passing such information to the function unit for various programs.

This embodiment is assumed that the program information of the digital broadcasting is extracted by the signal separation unit 32 so as to obtain the service information SI. However, the service information SI may be obtained from the external network 5 and the distributor via the communication I/F 39 and the mobile communication I/F 40. In this case, it is possible to omit the tuner/demodulator 31 and the signal separation unit 32 from the structure of the wireless terminal 3.

The storage 34 stores the application program and various types of information produced by the application program. It is further capable of storing the contents such as the video audio stream from signals received from the tuner/demodulator 31, the communication I/F 39, or the mobile communication I/F 40. The memory 33 allows function parts of the application program stored in the storage 34 to be loaded under the control of the control unit 37.

The display unit 38 displays the image/video images stored in the storage 34, broadcasted/distributed video images, UI for executing various operations, and Web browser. It is possible to display images and video images, for example, images produced by the application program, images and video data of the contents received via the tuner/demodulator 31, those received from the server 6 on the external network 5 via the communication I/F 39, those received from the TV receiver 1 via the communication I/F 39, and those distributed from the server on the communication network via the mobile communication I/F 40. The display unit 38 may be formed integrally with the touch panel as described below.

The input unit 41 is an input device that receives the user's input operation to the wireless terminal 3, and may be formed as a physical button and the touch panel. In the following description, the touch panel will be described as the example. However, the respective operations may be performed through the physical buttons.

In the case where the touch panel is employed, the screen of the Web contents may be moved freely by moving any position on the Web contents while being kept touched with the finger (dragging operation). The desired Web contents may be accessed on the browser by tapping the anchor tag designated with the URL (Uniform Resource Locator) of the linked information of the destination with the finger once (tapping operation). The screen may be scaled down by operating like pinching the object Web contents on the screen with two fingers (pinch in operation). The screen may be scaled up by making two fingers apart from each other at the object on the screen (pinch out operation). The screen of the Web contents may be rapidly scrolled by flicking the screen toward the specific direction with the finger (flicking operation).

The acceleration sensor unit 35 measures acceleration applied to the wireless terminal 3. The control unit 37 is capable of clarifying the upper part of the wireless terminal 3 by allowing the acceleration sensor unit 35 to measure the gravitational acceleration. The upper part of the screen to be displayed on the display unit 38 is displayed so as to be aligned with the upper part measured by the acceleration sensor unit 35. This makes it possible to display the screen adapted to that of the wireless terminal 3 held by the user. The geomagnetic sensor unit 36 measures geomagnetism using a plurality of magnetometric sensors.

The GPS receiver unit 42 receives the signal transmitted from a plurality of satellites using GPS (Global Positioning System). The control unit 37 is capable of calculating the current position of the wireless terminal 3 based on the signal received by the GPS receiver unit 42. The gyro sensor unit 43 measures the angular velocity of the wireless terminal 3 generated when it is moved by the user.

### <Software Structure>

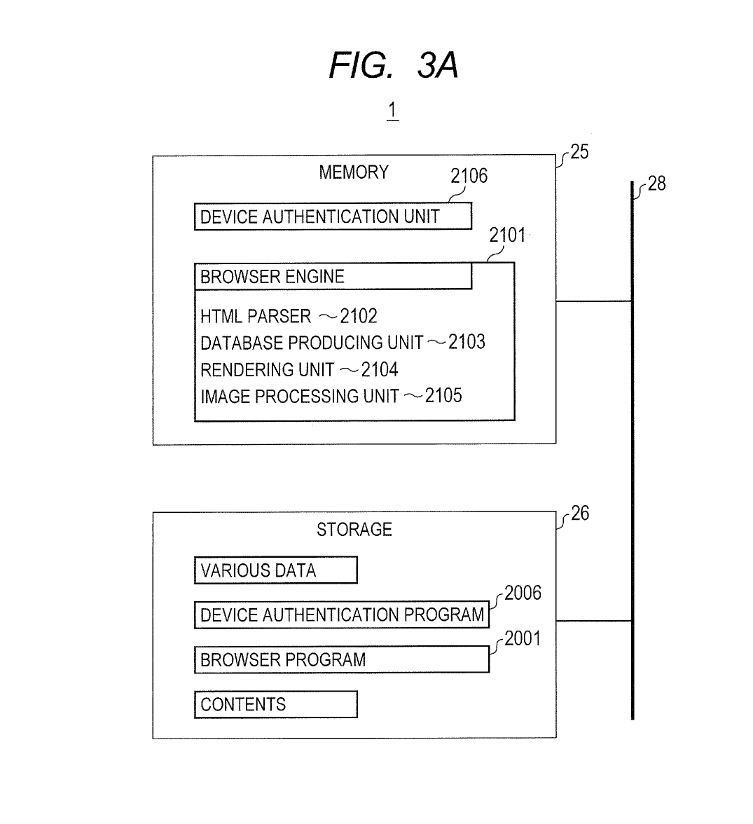

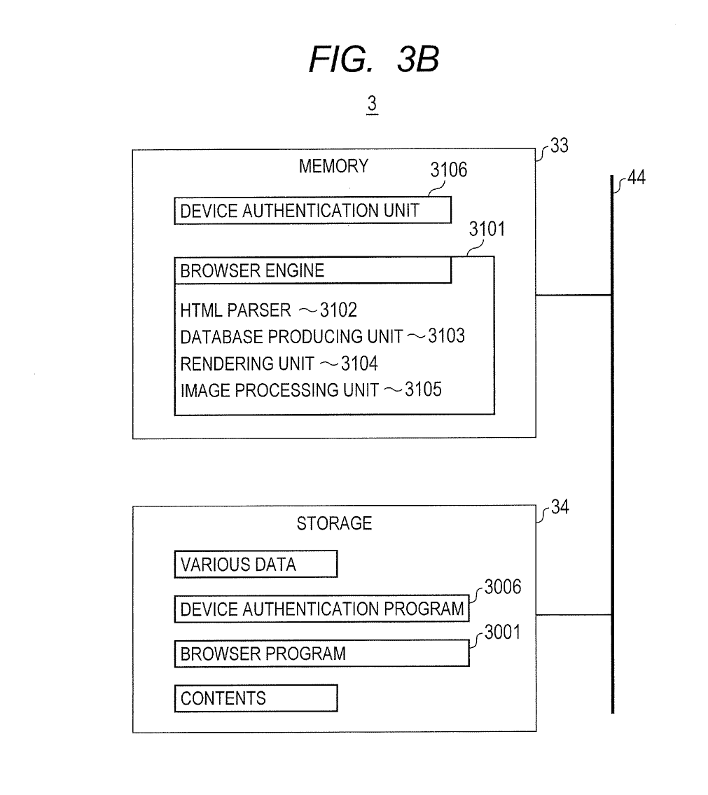

FIG. 3A illustrates structures of the memory 25 and the storage 26 within the TV receiver 1 as shown in FIG. 2A. FIG. 3B illustrates structures of the memory 33 and the storage 34 within the wireless terminal 3 as shown in FIG. 2B. They are common in the structure, which will be described collectively. The code in a parenthesis in the following description refers to the code indicating the part of the wireless terminal 3 shown in FIG. 3B.

Referring to FIG. 3A (FIG. 3B), the storage 26 (34) stores a browser program 2001 (3001) and a device authentication program 2006 (3006). This shows that those programs are loaded in the memory 25 (33) as the browser engine 2101 (3101) and a device authentication unit 2106 (3106) by the control unit 24 (37). The browser program 2001 (3001) and the device authentication program 2006 (3006) may be stored in the storage 26 (34) at the time of shipment of the product, or downloaded via the communication I/F 22 (39). The control unit 24 (37) executes those programs so as to realize various functions. The description below is assumed that they are realized mainly by the program function unit within the memory 25 (33).

The browser engine 2101 (3101) includes various function blocks such as an HTML parser 2102 (3102), a database producing unit 2103 (3103), a rendering unit 2104 (3104), and an image processing unit 2105 (3105).

The HTML parser 2102 (3102) analyzes the logical structure of the HTML data obtained via the control unit 24 (37), and interprets the obtained HTML data so as to be converted into inner data used for the TV receiver 1 (wireless terminal 3). The database producing unit 2103 (3103) produces the database relevant to the corresponding HTML data structure.

The rendering unit 2104 (3104) produces the layout structure that contains information in the expression format defined by each tag based on the database. Based on the layout structure, the browser display screen is produced just in accordance with the data having the size, position and image imported. The rendering unit 2104 of the TV receiver 1 controls the size and position of the images to be displayed on the display unit 20 based on the display position information transmitted from the wireless terminal 3. Meanwhile, the rendering unit 3104 of the wireless terminal 3 obtains the position of the screen displayed on the display unit 38 so as to produce the display position information and transmit the information to the rendering unit 2104 of the TV receiver 1. The image processing unit 2105 (3105) converts the obtained image file into the image data in the bitmap format and the like based on the image file information such as the position of the image file and the image file name, in the HTML data designated with the image tag.

The device authentication unit 2106 (3106) will be described hereinafter. The TV receiver 1 is configured to allow storage of the authentication information such as the user ID and password which have been set by the user's input through the input unit 23, or preliminarily set before shipment of the TV receiver 1 from the factory in various types of data of the storage 26. The device authentication unit 2106 refers to the data. It is assumed that the authentication information may be displayed on the display unit 20 by the user's operation or the user is allowed to confirm the authentication information in reference to the document attached to the TV receiver 1 at the time of purchasing.

The device authentication unit 3106 of the wireless terminal 3 stores the authentication information input through the user's operation received by the input unit 41 in various types of data as the authentication information so as to receive authentication from the TV receiver 1. The information is transmitted to the device authentication unit 2106 of the TV receiver 1 via the communication I/Fs 39 and 22.

The device authentication unit 2106 of the TV receiver 1 compares the authentication information stored in various types of data with the one transmitted from the device authentication unit 3106 of the wireless terminal 3. If there is correspondence in the authentication information, connection to the device authentication unit 3106 of the wireless terminal 3 is authenticated. Meanwhile, if the authentication information is incorrect, connection from the device authentication unit 3106 is not authenticated.

The above description is only an example of authentication method. In order to connect the TV receiver 1 and the wireless terminal 3 through the wireless LAN, the authentication/encryption method using the SSID (Service Set Identifier) and WEP key or WPS key may be employed. The known technique may be employed as the method of authentication and encrypting the information transmitted/received upon success of authentication with no specific restriction.

### <Data Format>

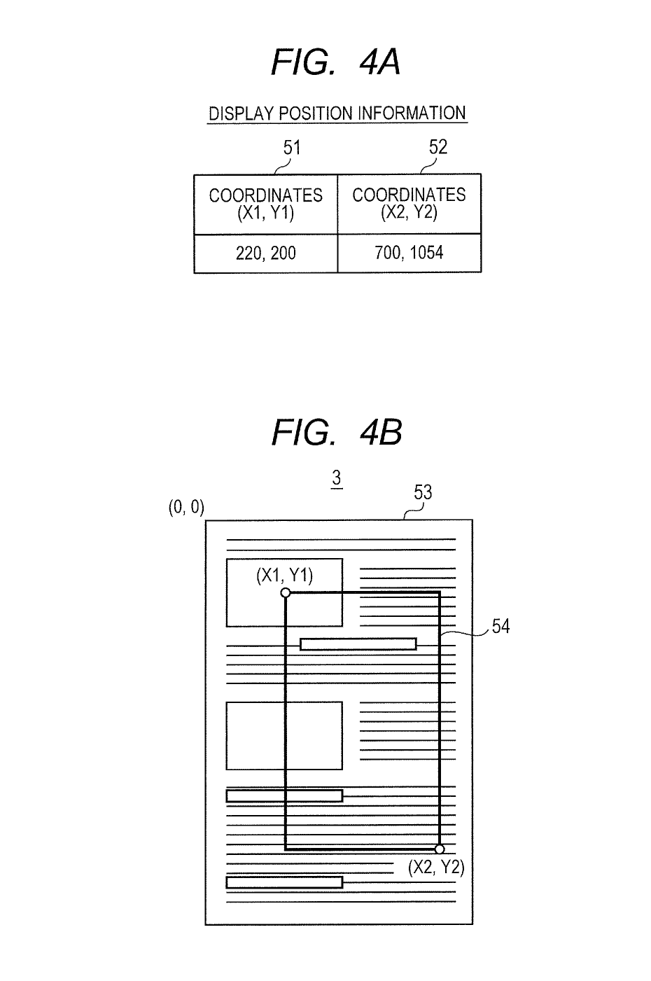

The display position information and the data format thereof in the network terminal system according to the embodiment will be described. FIG. 4A illustrates an example of the data format of the display position information transmitted to the TV receiver 1 from the wireless terminal 3. The position information that relates to the display area of the Web contents is transmitted to the rendering unit 2104 of the TV receiver 1 from the rendering unit 3104 of the wireless terminal 3. The display position information is formed in the format of coordinates (X1, Y1) 51 and (X2, Y2) 52. FIG. 4B illustrates the positional relationship between the display area of the wireless terminal 3 and the Web contents. Assuming that the zero point (0, 0) of the coordinates is set at the upper left corner of the Web contents 53, the coordinates (X1, Y1) 51 are set at the upper left corner of the display area 54, and the coordinates (X2, Y2) 52 are set at the lower right corner of the display area 54.

### <Operating Sequence>

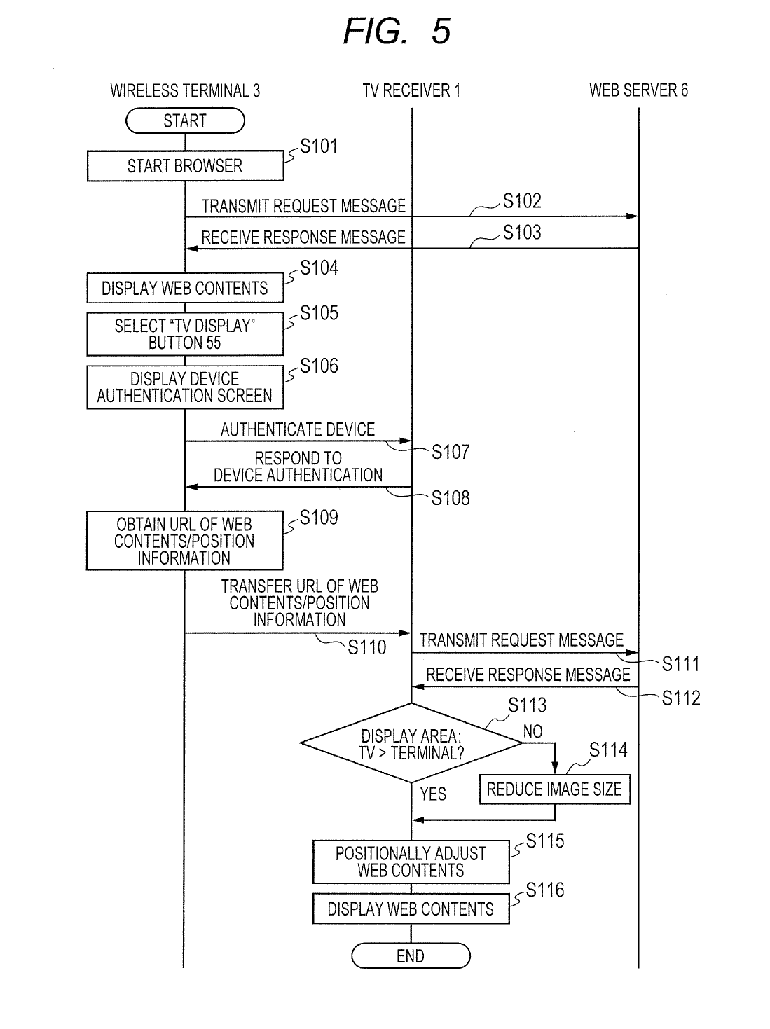

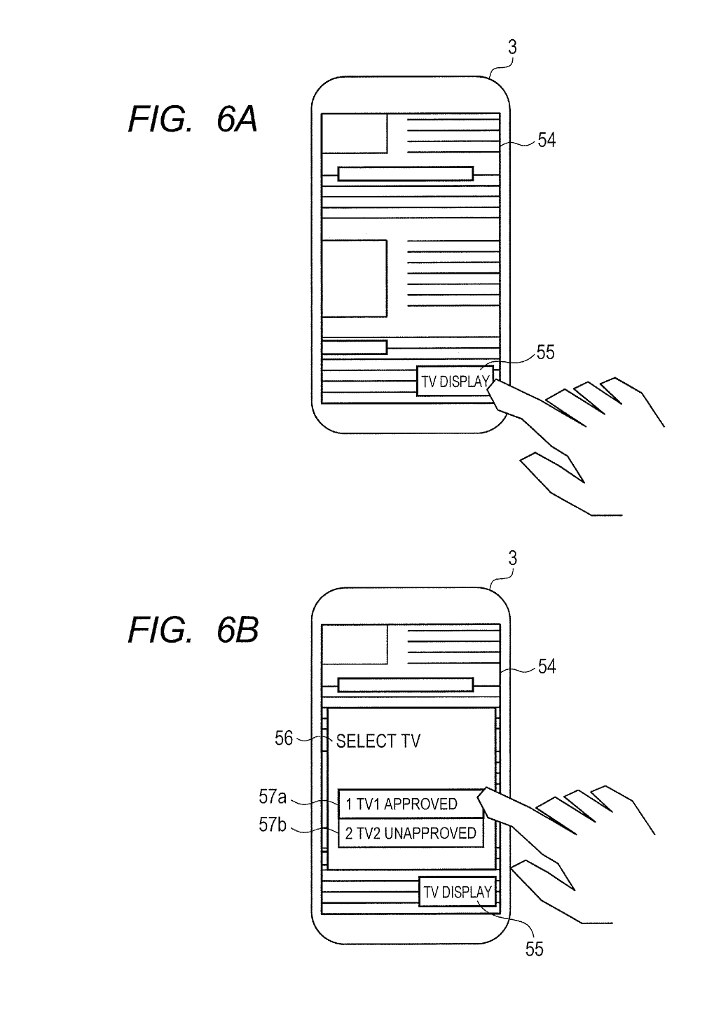

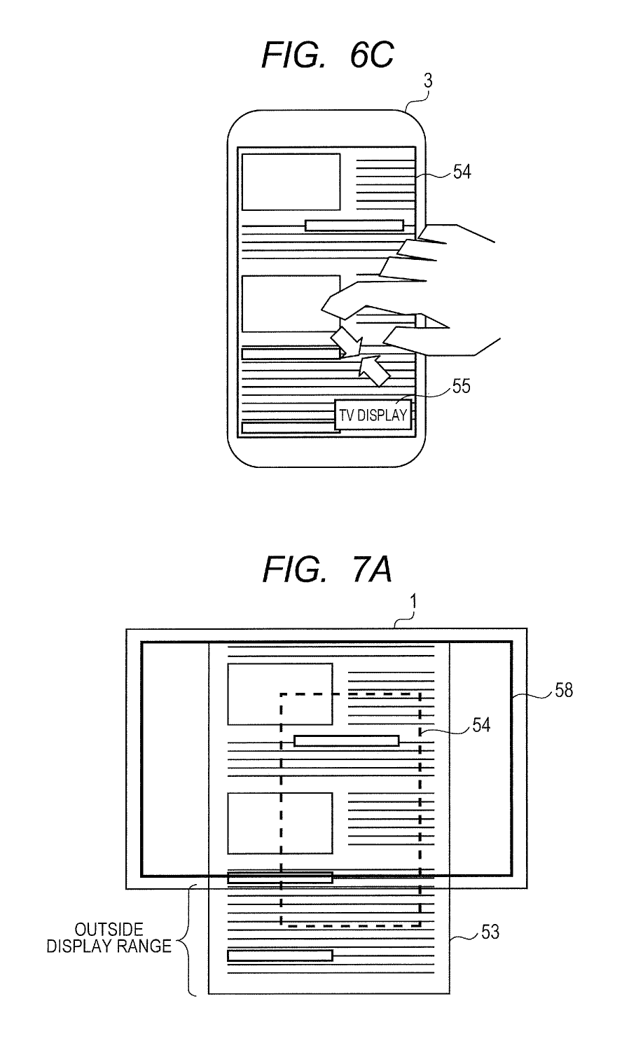

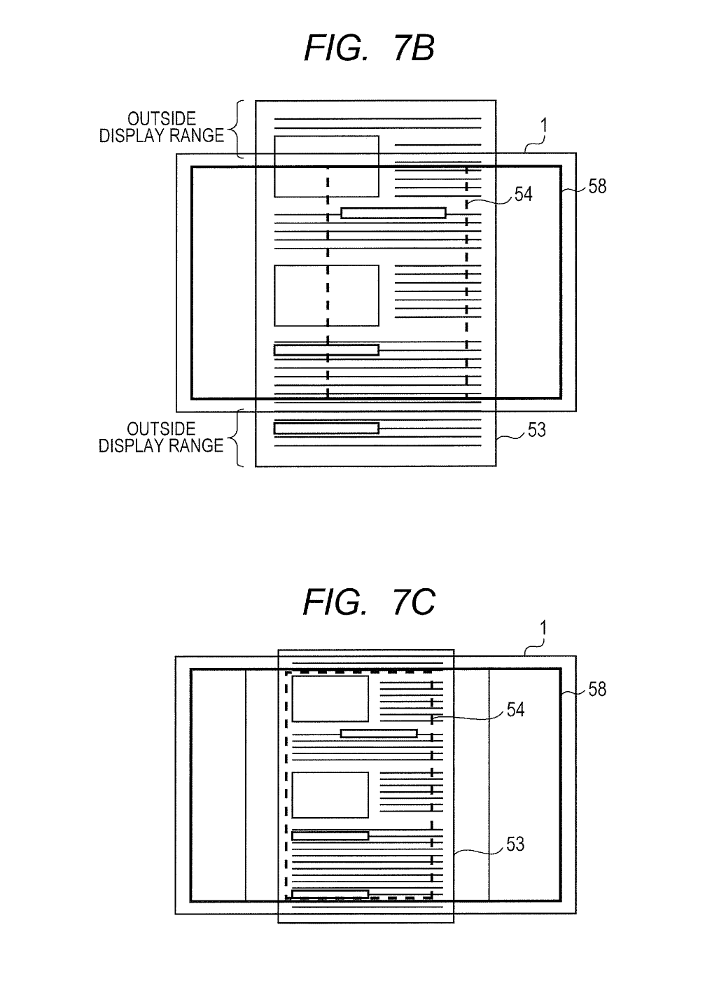

FIG. 5 represents the operating sequence of the embodiment. In this embodiment, the user operates the input unit 41 of the wireless terminal 3 to start the browser thereof, and display Web contents on the TV receiver 1. In this case, the wireless terminal 3 obtains the information such as the Web contents from the server (Web server) 6 via the external network 5. However, it is possible to obtain the information from the communication network via the mobile communication I/F 40 and the base station 8. FIGS. 6A, 6B and 6C illustrate an example of the display screen and operation of the wireless terminal 3. FIGS. 7A, 7B and 7C illustrate an example of the display screen of the TV receiver 1.

Operations of the respective steps will be described.

S101: In response to the instruction to start the browser from the input unit 41, the control unit 37 of the wireless terminal 3 starts the browser engine 3101. The browser engine 3101 then accesses the URL of the resource preliminarily set as the website.

S102: The browser engine 3101 transmits the request message requiring the resource such as Web contents in accordance with HTTP to the server 6 identified by the URL on the network from the external network 5 via the control unit 37, the communication I/F 39, and the wireless router 4.

S103: The server 6 identified by the URL produces the response message corresponding to the received request message, and returns the message. The returned response message is input to the browser engine 3101 via the external network 5.

S104: The HTML document is embedded in the response message, and the HTML parser 3102, the database producing unit 3103, the rendering unit 3104, and the image processing unit 3105 of the browser engine 3101 produce the browser screen so as to display the Web contents on the display unit 38.

S105: Upon user operation through the input unit 41, the wireless terminal 3 proceeds to step of displaying the Web contents on the TV receiver 1. FIG. 6A illustrates an example of the operation screen for displaying the Web contents on the TV receiver 1. The display unit 38 of the wireless terminal 3 includes a “TV display” button 55 used for displaying the same contents as the currently displayed Web contents on the display unit 20 of the TV receiver 1. The user then taps the “TV display” button 55 with finger.

S106: Upon operation of the “TV display” button 55, the control unit 37 allows display of the authentication screen on the display unit 38 for device authentication. FIG. 6B illustrates an example of the device authentication screen. If the device connected to the network is located, such device is displayed on the device list 56 irrespective of the status of the device whether it has been authenticated or unauthenticated. The located device name is stored in the storage 34 together with the information in the authenticated or unauthenticated status. If a certain device has been located previously, and is not located in this time, such device may be displayed in the different color so as to be distinguished from the other device. Referring to FIG. 6B, “TV 1 (TV receiver 1)” 57a and “TV2 (TV receiver 2)” 57b are displayed on the device list 56, indicating that the TV 1 has been already authenticated.

S107: When the user selects the “TV1” 57a for authentication, the device authentication unit 3106 proceeds to step of receiving authentication from the TV receiver 1. For this, the authentication information data such as the user ID and password which have been preliminarily stored in various data are transmitted to the device authentication unit 2106 of the TV receiver 1 via the communication I/Fs 39 and 22.

S108: The device authentication unit 2106 of the TV receiver 1 compares the authentication information transmitted from the device authentication unit 3106 of the wireless terminal 3 with the one stored in various data. If there is correspondence in the authentication information, connection to the device authentication unit 3106 is authenticated. The wireless terminal 3 stores the last authenticated device in the storage 34 so as to omit the authentication screen as shown in FIG. 6B. If there is no correspondence in the authentication information, the authentication screen as shown in FIG. 6B may be displayed.

S109: The wireless terminal 3 obtains URL of the currently displayed Web contents on the display unit 38 from the browser engine 3101, and further obtains position information data 51 and 52 as shown in FIG. 4A from the rendering unit 3104.

S110: The wireless terminal 3 transfers the obtained URL of the Web contents and the position information to the browser engine 2101 of the TV receiver 1 via the communication I/F 39, the wireless router 4, the communication I/F 22, and the control unit 24.

S111: The TV receiver 1 accesses the external network 5 to obtain the Web contents. First, the browser engine 2101 of the TV receiver 1 transmits the request message requiring resource such as the Web contents in accordance with the aforementioned HTTP to the server 6 identified by the URL on the network from the external network 5 via the control unit 24, the communication I/F 22, and the wireless router 4.

S112: The server 6 corresponding to the designated URL produces the response message corresponding to the received request message, and returns the message. The returned response message is input to the browser engine 2101 of the TV receiver 1 via the external network 5. The HTML document is embedded in the response message so as to produce the browser display screen through the HTML parser 2102, database producing unit 2103, the rendering unit 2104, and the image processing unit 2105 of the browser engine 2101 produces the browser display screen.

S113: Display screen on the TV receiver 1 is positionally adjusted. FIG. 7A shows comparison between the display area 58 of the display unit 20 of the TV receiver 1 and the display area 54 of the display unit 38 of the wireless terminal 3. If the display area 58 of the TV receiver 1 is larger than the display area 54 of the wireless terminal 3 (S113: YES), the process proceeds to step S115. If the display area 58 is smaller than the display area 54 (S113: NO), the process proceeds to step S114.

S114: The rendering unit 2104 of the TV receiver 1 scales down the image of the contents so that the contents at least displayed on the display area 54 of the wireless terminal 3 have the size that can be displayed on the display area 58 of the TV receiver 1 based on the position information data 51 and 52 received from the wireless terminal 3. FIG. 7C illustrates the state where the image on the TV receiver 1 is scaled down. Scaling down of the Web contents 53 displayed on the TV receiver 1 allows the display area 54 of the wireless terminal 3 to be entirely displayed.

S115: The rendering unit 2104 of the TV receiver 1 adjusts the display position so that the contents at least displayed on the display area 54 of the wireless terminal 3 are displayed on the display area 58 of the TV receiver 1 based on the position information data 51 and 52 received from the wireless terminal 3. FIG. 7B shows the state where the display position of the contents is adjusted, and the display area 54 of the wireless terminal 3 is contained in the display area 58 of the TV receiver 1.

S116: The same Web contents as those displayed on the wireless terminal 3 are displayed on the display unit 20 of the TV receiver 1. The display area information of the display unit 38 of the wireless terminal 3 may be calculated using the position information data 51 and 52. However, it may have independent data format contained in the position information.

FIG. 7A shows the state of the TV receiver 1 before adjusting position and size, in other words, a layout example of the Web contents in reference to the upper left position of the Web contents region. In this case, all the display area 54 of the wireless terminal 3 cannot be displayed, and accordingly, the lower side part of the display area 54 is out of the display range. On the contrary, FIG. 7B shows the layout example of the Web contents after adjusting the position and size according to the present embodiment. In this case, all the display area 54 of the wireless terminal 3 may be displayed, which provides the advantage of ensuring correspondence in the Web screen between the wireless terminal 3 and the TV receiver 1.

A possible modified example of the aforementioned embodiment will be described. The modified example allows display of the region corresponding to the display area 54 of the wireless terminal 3 in the display unit 20 of the TV receiver 1 using the frame border based on the position information received from the wireless terminal 3. If the Web contents are activated by the wireless terminal 3, the browser of the TV receiver 1 may be started background synchronously so as to avoid the delay in the start of the browser of the TV receiver 1.

This makes it possible to display the Web contents at least displayed on the display unit 38 of the wireless terminal 3 on the display unit 20 of the TV receiver 1 without missing any part. In the case where the display area is changed by such operation as dragging with the finger on the touch panel of the wireless terminal 3, the position information is transmitted at a predetermined time interval or a predetermined timing so as to display the display area 54 of the wireless terminal 3 on the display area 58 of the TV receiver 1 by following up the dragging operation. In this case, the position information may be updated at the timing when the display area 54 of the wireless terminal 3 deviates from the display area 58 of the TV receiver 1.

FIG. 6C illustrates the state of the wireless terminal 3 where the Web contents are scaled up or down. The scaling up or down of the Web contents may be realized by performing “pinch in” or “pinch out” operation. In this case, the frame position or the frame size on the TV receiver 1 may be changed in response to scaling up/down of the display area 54 of the wireless terminal 3.

When displaying the contents browsed by the wireless terminal such as the mobile phone on the TV receiver, the related art has to search the URL of the currently browsed site by starting the browser screen, and set the searched URL for the TV receiver. The display capacity and property of the display screen of the wireless terminal are different from those of the TV receiver, resulting in different display area and position. It is therefore difficult for the related art to display the contents in the same range. The embodiment allows the Web contents displayed on the wireless terminal to be displayed on the TV receiver without missing any part of the screen through simple operations.

### Second Embodiment

A second embodiment according to the present invention will be described. This embodiment is configured to share the session information between the wireless terminal 3 and the TV receiver 1.

### <System Structure>

The network terminal system according to the second embodiment is similar to the first embodiment (FIG. 1) as well as inner structures of the TV receiver 1 and the wireless terminal 3 (FIGS. 2A and 2B), explanations of which will be omitted.

### <Software Structure>

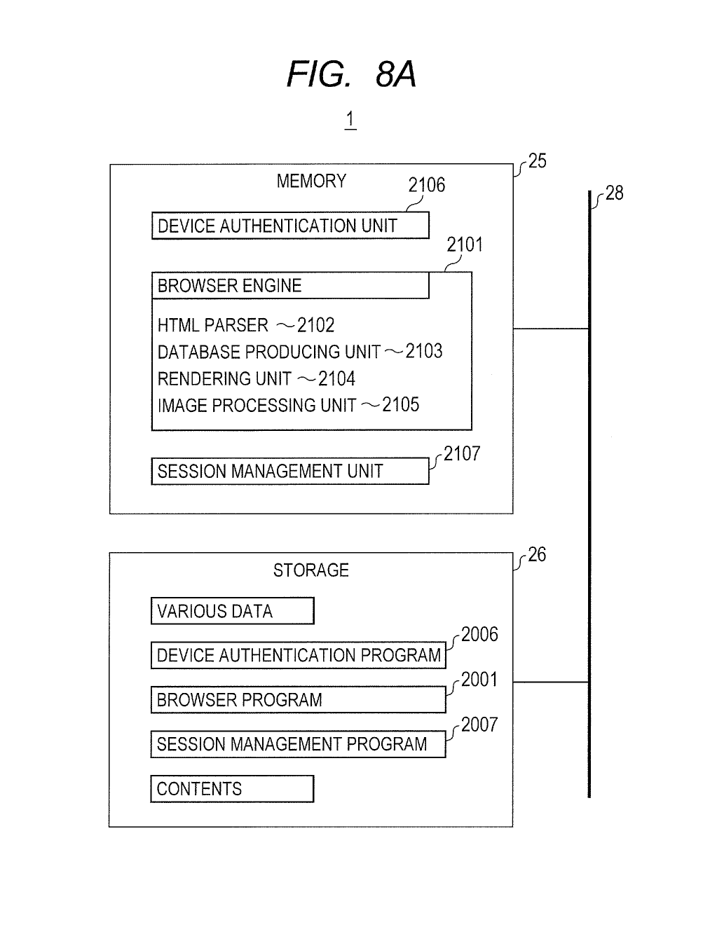

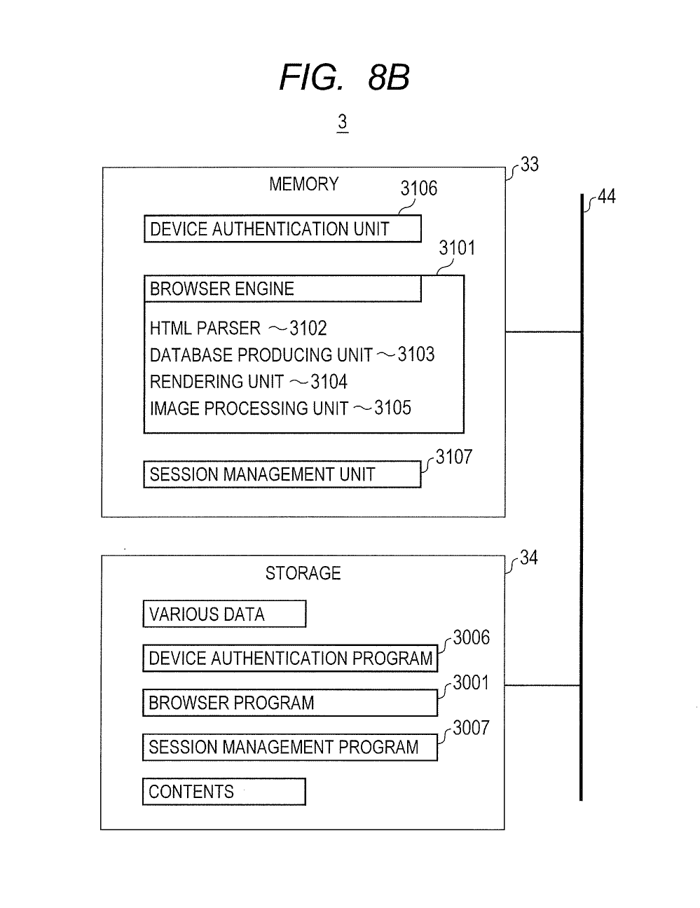

FIG. 8A shows structures of the memory 25 and the storage 26 within the TV receiver 1. FIG. 8B shows structures of the memory 33 and the storage 34 within the wireless terminal 3. The difference in the structure between the first embodiment (FIGS. 3A and 3B) and the second embodiment will be described.

The storage 26 (34) stores a session management program 2007 (3007) in addition to the browser program 2001 (3001) and the device authentication program 2006 (3006). A session management unit 2107 (3107) which loads the session management program 2007 (3007) is added to the memory 25 (33) in addition to the browser engine 2101 (3102) and the device authentication unit 2106 (3106). The session management program 2007 (3007) is stored or obtained in the similar way to the other program as described in the first embodiment.

The session management unit 3107 of the wireless terminal 3 temporarily stores a unique session ID for identifying the user received from the server 6, and session variables such as the screen transition state inherent to the user and the contents page, which are correlated to the session ID in the memory 33 as the session information. The stored session information is transmitted to the session management unit 2107 of the TV receiver 1 via the communication I/Fs 39 and 22.

The session management unit 2107 of the TV receiver 1 temporarily stores the session information received from the session management unit 3107 of the wireless terminal 3 in the memory 25 as the session information of the TV receiver 1. This session information is transmitted to the server 6 upon access from the TV receiver 1 to the server 6.

The session information is shared between the wireless terminal 3 and the TV receiver 1 so that the respective pages of the Web contents may also be shared.

The session information may be obtained only when the authentication information has correspondence with the correlated authentication information to be described later. The session information may also be embedded in HTTP cookie information or URL. The session information may use the hash value calculated using the hash function. The session information coded through the wireless terminal 3 may be transmitted to the TV receiver 1 and decoded thereby for the use.

### <Operating Sequence>

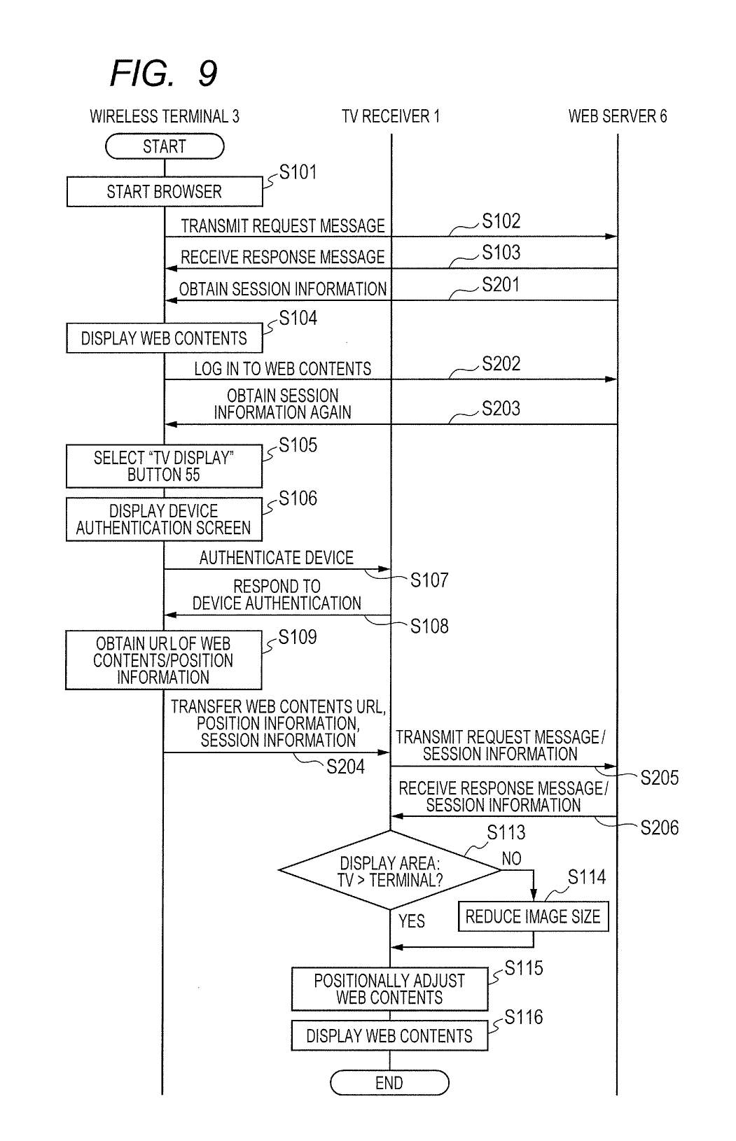

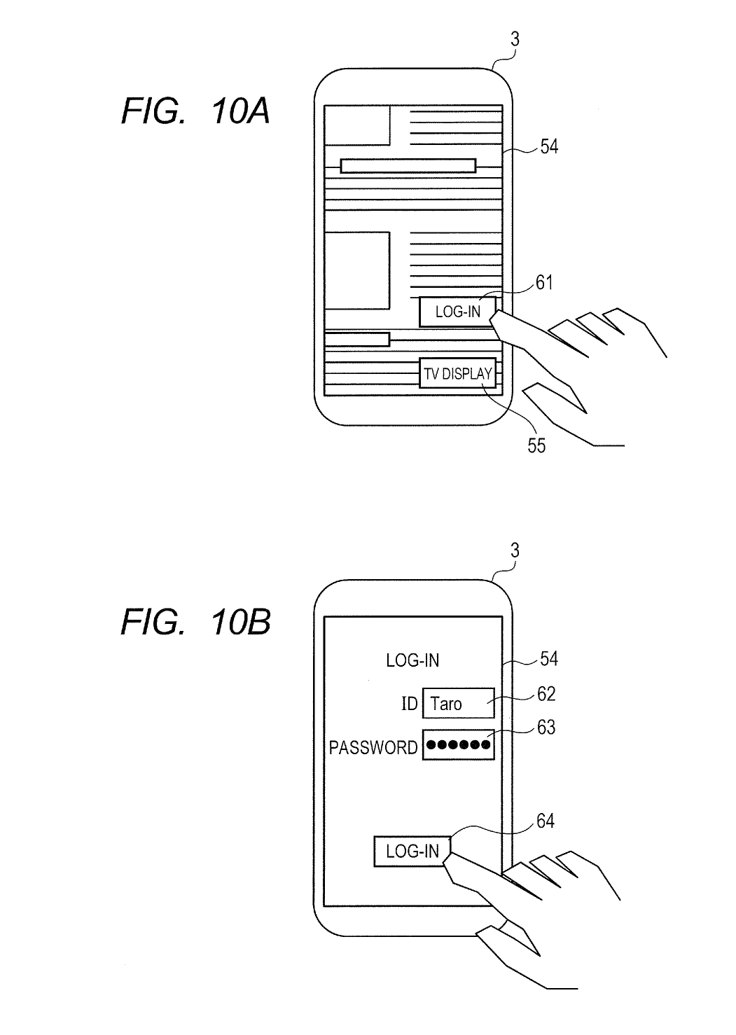

FIG. 9 shows the operating sequence of the second embodiment. FIGS. 10A and 10B illustrate the display screen and operation of the wireless terminal 3. In this embodiment, steps S201 to S203 are added to the sequence (S101 to S116) of the first embodiment (FIG. 5), and replacing the sequence from S110 to S112 with the sequence from S204 to S206. Operations of the respective steps will be described sequentially, and the section that has been already described in the first embodiment (FIG. 5) will be briefly explained.

S101: Upon reception of the instruction of starting the browser from the input unit 41, the control unit 37 of the wireless terminal 3 starts the browser engine 3101.

S102: The browser engine 3101 transmits the request message requiring the resource such as the Web contents to the Web server 6 identified by the URL on the network from the external network 5.

S103: The server 6 identified by the URL produces the response message corresponding to the received request message, and returns the message. The returned response message is input to the browser engine 3101.

S201: The server 6 identified by the URL produces the session information for uniquely identifying the user corresponding to the received request message, and returns the information. The returned session information is input to the browser engine 3101, and temporarily stored in the memory 33.

S104: The response message has the HTML document embedded therein. The browser engine 3101 produces the browser display screen, and displays the Web contents on the display unit 38.

The operation of accessing the page that requires authentication process from the Web contents displayed on the display unit 38 will be described.

S202: Upon reception of the user operation from the input unit 41, the log-in to the Web contents is performed. FIG. 10A shows an example of the log-in operation screen. When the user selects a “log-in” button 61 displayed on the Web contents, the browser engine 3101 transmits the request to display the user log-in screen to the server 6. Then the log-in page as shown in FIG. 10B is displayed. The user inputs the ID 62 and the password 63, and selects a “log-in” button 64 for enter. The browser engine 3101 then transmits the authentication information to the server 6.

S203: Upon success of the authentication, the server 6 produces the Web page contents and the new session information, and transmits the data to the browser engine 3101. At this time, the previous session information for the authenticated contents is destroyed or initialized. The browser engine 3101 displays the received authenticated Web page contents on the display unit 38, and temporarily stores the new session information in the memory 33. The obtained session information is used to correlate the user with the respective pages of the Web contents.

S105: The wireless terminal 3 proceeds to step of displaying the Web contents on the TV receiver 1. As FIG. 6A illustrates, the user operates the “TV display” button 55 provided on the display unit 38 of the wireless terminal 3.

S106: The control unit 37 displays the device authentication screen that contains the device list 56 on the display unit 38 as FIG. 6B illustrates.

S107: If the user selects the “TV1” 57a as the device to be authenticated, the device authentication unit 3106 transmits the authentication information such as the user ID and password to the device authentication unit 2106 of the TV receiver 1.

S108: The device authentication unit 2106 of the TV receiver 1 compares the stored authentication information with the one transmitted from the wireless terminal 3. If there is correspondence in the authentication information, connection authentication is given to the device authentication unit 3106 of the wireless terminal 3.

S109: Upon success of the authentication, the wireless terminal 3 obtains the URL of the Web contents currently displayed on the display unit 38 from the browser engine 3101, the temporarily stored session information from the memory 33, and the position information shown in FIG. 4A from the rendering unit 3104.

S204: The wireless terminal 3 transfers the URL of the Web contents, the session information, and the position information which have been obtained to the browser engine 2101 of the TV receiver 1 via the communication I/F 39, the wireless router 4, the communication I/F 22, and the control unit 24.

S205: The browser engine 2101 of the TV receiver 1 temporarily stores the received session information and the position information, and transmits the request message requiring the resource such as the Web contents in accordance with the aforementioned HTTP and the session information to the server identified by the URL on the network from the external network 5 via the control unit 24, the communication I/F 22 and the wireless router 4.

S206: The server 6 corresponding to the designated URL produces the response message corresponding to the user identified by the session information and the session information with updated contents page, and returns the data. The returned response message and the session information will be input to the browser engine 2101 of the TV receiver 1 via the external network 5. The browser engine 2101 produces the browser display screen in accordance with the response message. The session information that has been temporarily stored in the memory 25 is overwritten by the returned session information, which will be stored.

S113: Then the position adjustment of the display screen of the TV receiver 1 is executed. As described referring to FIG. 7A, if the display area 58 of the TV receiver 1 is larger than the display area 54 of the wireless terminal 3 (S113: YES), the process proceeds to step S115. If the display area 58 is smaller than the display area 54 (S113: NO), the process proceeds to step S114.

S114: The rendering unit 2104 of the TV receiver 1 scales down the image of the contents so that the contents displayed on the display area 54 of the wireless terminal 3 is displayed in the display area 58 of the TV receiver 1 (see FIG. 7C).

S115: The rendering unit 2104 of the TV receiver 1 adjusts the display position so that the contents displayed on the display area 54 of the wireless terminal 3 is displayed in the display area 58 of the TV receiver 1 (see FIG. 7B).

S116: The Web contents are displayed on the display unit 20 of the TV receiver 1.

The aforementioned operating sequence is assumed to adjust the position of the display screen of the TV receiver 1 in process steps from S113 to S115 in the same manner as the first embodiment. However, this adjustment operation may be omitted.

If the user stops the browser engines 2101 and 3101 by operating the input units 23 and 41, the session information may be destroyed or initialized so as to prevent the Web spoofing owing to leakage of the session information. If the device authentication with respect to the wireless terminal 3 and the TV receiver 1 fails, the session information may be destroyed or initialized.

When returning the display of the Web contents to the wireless terminal 3, the session information may be transmitted to the browser engine 3101 of the wireless terminal 3 from the browser engine 2101 of the TV receiver 1 via the communication I/F 22, the wireless router 4, the communication I/F 39 and the control unit 37.

According to the second embodiment, the Web contents displayed on the wireless terminal 3 requiring the authentication may be displayed on the TV receiver 1 likewise the wireless terminal 3 by taking over the session information from the wireless terminal 3 to the TV receiver 1.

### Third Embodiment

A third embodiment according to the present invention will be described. This embodiment has an additional function that allows transition to the relevant screen based on the linked information.

### <System Structure>

The network terminal system according to the third embodiment is similar to the system according to the first embodiment (FIG. 1) as well as the inner structures of the TV receiver 1 and the wireless terminal 3 (FIGS. 2A and 2B), explanations of which will be omitted.

### <Software Structure>

The software structure according to the third embodiment is similar to the first embodiment (FIGS. 3A and 3B), explanations of which will be omitted.

### <Operating Sequence>

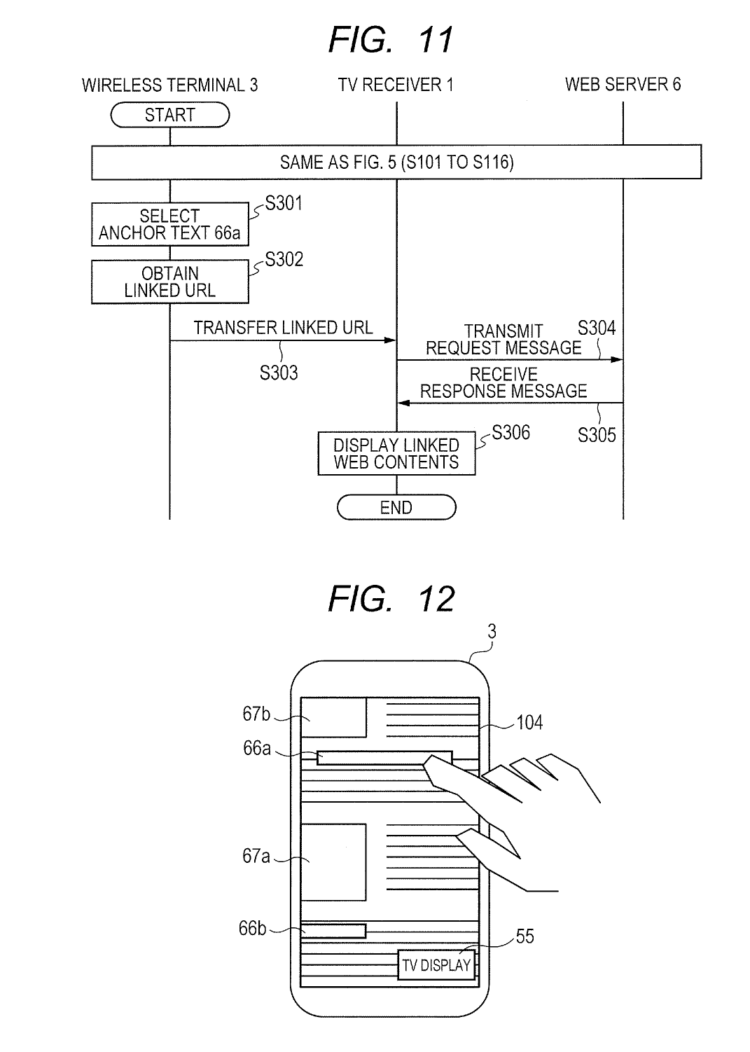

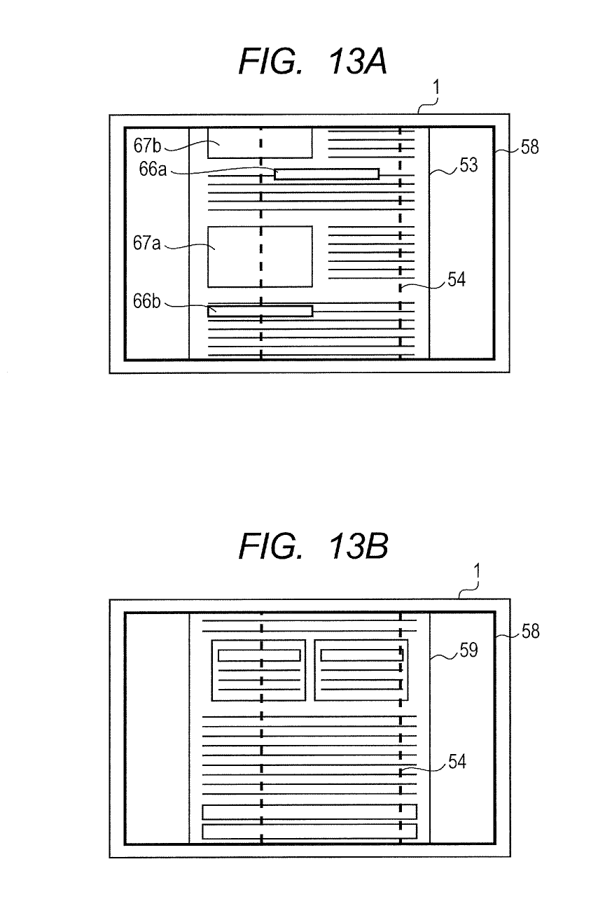

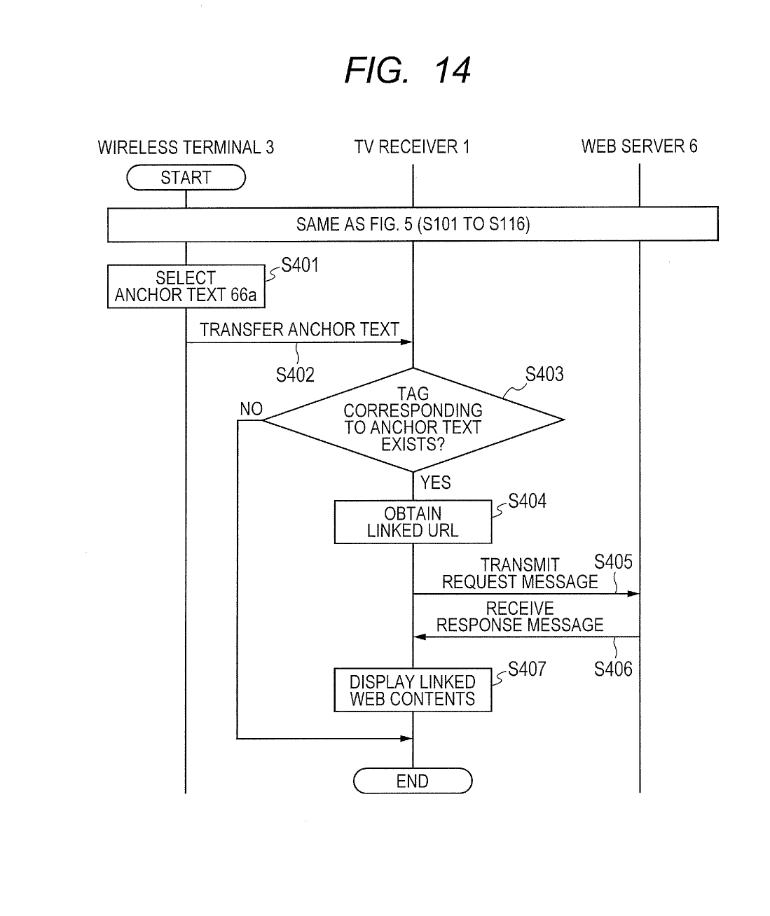

FIG. 11 represents the operating sequence according to the third embodiment. FIG. 12 illustrates the display screen and operation of the wireless terminal 3. FIG. 13A illustrates the display screen of the TV receiver 1, and FIG. 13B illustrates the display screen after transition of the TV receiver 1. In this embodiment, process steps S301 to S306 are newly added to the sequence (S101 to S116) of the first embodiment (FIG. 5).

As a result of the sequence (S101 to S116), the display unit 20 of the TV receiver 1 displays the same Web contents as those displayed on the wireless terminal 3. FIG. 12 illustrates the display screen of the wireless terminal 3, and FIG. 13A illustrates the display screen of the TV receiver 1. The display area 54 of the wireless terminal 3 is positionally adjusted to be in the display area 58 of the TV receiver 1.

Referring to the display screen of FIG. 12, each of the anchor texts 66a and 66b in the contents denotes the text having the set link between anchor tags <a> to which the URL of the linked information is added. Selection of the anchor texts 66a or 66b by the input unit 41 allows transition to the target link identified by the URL of the linked information. The anchor texts 66a and 66b are displayed usually having characters in blue colored or underlined for emphasizing that they are selectable. Likewise, each of the anchor objects 67a and 67b denotes the object having the set link between anchor tags <a> to which the URL of the linked information is added. Selection of the anchor objects 67a, 67b by the input unit 41 allows transition to the target link identified by the URL of the linked information. The display screen of the TV receiver 1 shown in FIG. 13A has the similar structure.

The respective process steps shown in FIG. 11 will be described sequentially.

S301: Referring to the display screen of the wireless terminal 3 shown in FIG. 12, it is assumed that the anchor text 66a in the contents is tapped by the user.

S302: The browser engine 3101 obtains the URL of the linked information of the anchor text 66a.

S303: The obtained URL of the linked information is transferred to the browser engine 2101 of the TV receiver 1 via the communication I/F 39, the wireless router 4, the communication I/F 22, and the control unit 24.

S304: The browser engine 2101 of the TV receiver 1 transmits the request message requiring the resource such as the Web contents in accordance with HTTP to the server 6 identified by the URL on the network from the external network 5 via the communication I/F 22 and the wireless router 4.

S305: The server 6 corresponding to the designated URL produces the response message corresponding to the received request message, and returns the message. The returned response message is input to the browser engine 2101 of the TV receiver 1 via the external network 5.

S306: The response message has the HTML document embedded therein, and the browser display screen is produced by the HTML parser 2102, the database producing unit 2103, the rendering unit 2104, and the image processing unit 2105 of the browser engine 2101 so that linked Web contents are displayed on the display unit 20 of the TV receiver 1. FIG. 13B illustrates the state where the linked Web contents are displayed on the display unit 20 of the TV receiver 1.

This embodiment has been explained using the anchor text 66a. This also applies to the use of the linked information such as the anchor text 66b and the anchor objects 67a and 67b. This embodiment is configured to cause transition of the display screens of both the wireless terminal 3 and the TV receiver 1 to the linked Web contents in response to tapping of the anchor text 66a or the like displayed on the wireless terminal 3 as shown in FIG. 12. On the contrary, it is possible to cause transition only of the display screen of the TV receiver 1 to the linked Web contents 59 as shown in FIG. 13B while keeping the display screen of the wireless terminal 3 as shown in FIG. 12 and the display of the Web contents unchanged, that is, to serve as the screen exclusively for the screen transition.

The third embodiment allows the screen of the relevant information to be easily displayed on the TV receiver from the link tag of the Web contents displayed on the wireless terminal. There may be the case that dependent on the Web contents, the hierarchy of the link is so deep that it is troublesome to return to the source screen after transition to other screen. In such a case, the linked screen-transition page is displayed on the TV receiver, and the source screen is displayed on the wireless terminal so that both screens of the link and the source may be displayed simultaneously.

### Fourth Embodiment

A fourth embodiment according to the invention will be described. This embodiment is provided with an additional function of transition to the related screen by the anchor text. That is, this embodiment uses the anchor text information instead of using the linked information as described in the third embodiment.

### <System Structure>

The network terminal system according to the fourth embodiment is similar to the first embodiment (FIG. 1) as well as the inner structures of the TV receiver 1 and the wireless terminal 3 in the first embodiment (FIGS. 2A and 2B), explanation of which will be omitted.

### <Software Structure>

The software structure of the fourth embodiment is similar to that of the first embodiment (FIGS. 3A and 3B), explanation of which will be omitted.

### <Operating Sequence>

FIG. 14 shows the operating sequence of the fourth embodiment. In this embodiment, process steps S401 to S407 are newly added to the sequence (S101 to S116) of the first embodiment (FIG. 5).

As a result of the aforementioned sequence (S101 to S116), the display unit 20 of the TV receiver 1 displays the same Web contents as those displayed on the wireless terminal 3. FIG. 12 illustrates the display screen of the wireless terminal 3, and FIG. 13A illustrates the display screen of the TV receiver 1.

S401: Referring to the display screen of the wireless terminal 3 shown in FIG. 12, it is assumed that the anchor text 66a in the contents is tapped by the user's finger.

S402: The browser engine 3101 obtains the text information (text character string data) of the anchor text 66a, and transfers the data to the browser engine 2101 of the TV receiver 1 via the communication I/F 39, the wireless router 4, the communication I/F 22, and the control unit 24.

S403: The browser engine 2101 of the TV receiver 1 searches the anchor tag that corresponds to the input anchor text in the database producing unit 2103.

S404: If the tag that corresponds to the text is searched (S403: YES), the linked information is obtained based on the tag. Simultaneously, the rendering unit 2104 may be configured so that the anchor tag with the anchor text temporarily has the different color for distinguishing the subject anchor text from the other.

S405: The browser engine 2101 of the TV receiver 1 transmits the request message requiring the resource such as the Web contents in accordance with the linked information to the server 6 identified by the URL from the external network 5.

S406: The server 6 corresponding to the designated URL produces the response message corresponding to the received request message, and returns the message via the external network 5.

S407: The browser engine 2101 of the TV receiver 1 produces the browser display screen corresponding to the received response message, and displays the linked Web contents on the display unit 20. FIG. 13B shows the state where the display unit 20 of the TV receiver 1 displays the linked Web contents 59.

As described above, in the fourth embodiment, tapping of the anchor text on the wireless terminal 3 allows the operation similar to the case of selecting the anchor text of the Web contents on the TV receiver 1.

Generally, the TV receiver uses the cross type cursor operation button for operating the menu and program list. There may be often the case that the TV receiver employs the anchor cursor type that only selects the anchor text rather than the pointer type such as the touch panel which allows selection of the display area freely with the pointer. In such a case, it is possible to perform selection with the pointer type by tapping the anchor text of the wireless terminal on the touch panel.

The wireless terminal is configured to use the user agent function to identify the type of the terminal and the browser so that the Web contents suitable for the display capability of the terminal. In such a case, the wireless terminal receives the contents adapted to the mobile browser rather than those for full browser. This may cause the difference in the view of the browser and the linked URL between the TV receiver and the wireless terminal. This embodiment is capable of accessing the linked information of the anchor tag that corresponds to the anchor text, and accordingly, operating the Web contents with different view and linked URL in cooperation with the wireless terminal.

### Fifth Embodiment

A fifth embodiment according to the present invention will be described. The fifth embodiment is provided with an additional function of storing Web contents display history.

### <System Structure>

The network terminal system according to the fifth embodiment is similar to the first embodiment (FIG. 1) as well as the inner structures of the TV receiver 1 and the wireless terminal 3 (FIGS. 2A and 2B), explanations of which will be omitted.

### <Software Structure>

The software structure according to the fifth embodiment is similar to the first embodiment (FIGS. 3A and 3B), explanation of which will be omitted. The memory 33 of the wireless terminal 3 of this embodiment includes a display history storing function for storing the display history of the Web contents. The browser engine 3101 includes a display history reading function for reading the linked information from the display history stored in the memory 33. Many Web browsers include “bookmark” and “history” functions which store the information that has been browsed by the user in the past for reuse. This embodiment will be described, taking the operation of “back” and “next” of the tree hierarchy as one of the “history” functions as an example.

### Example of Screen Display

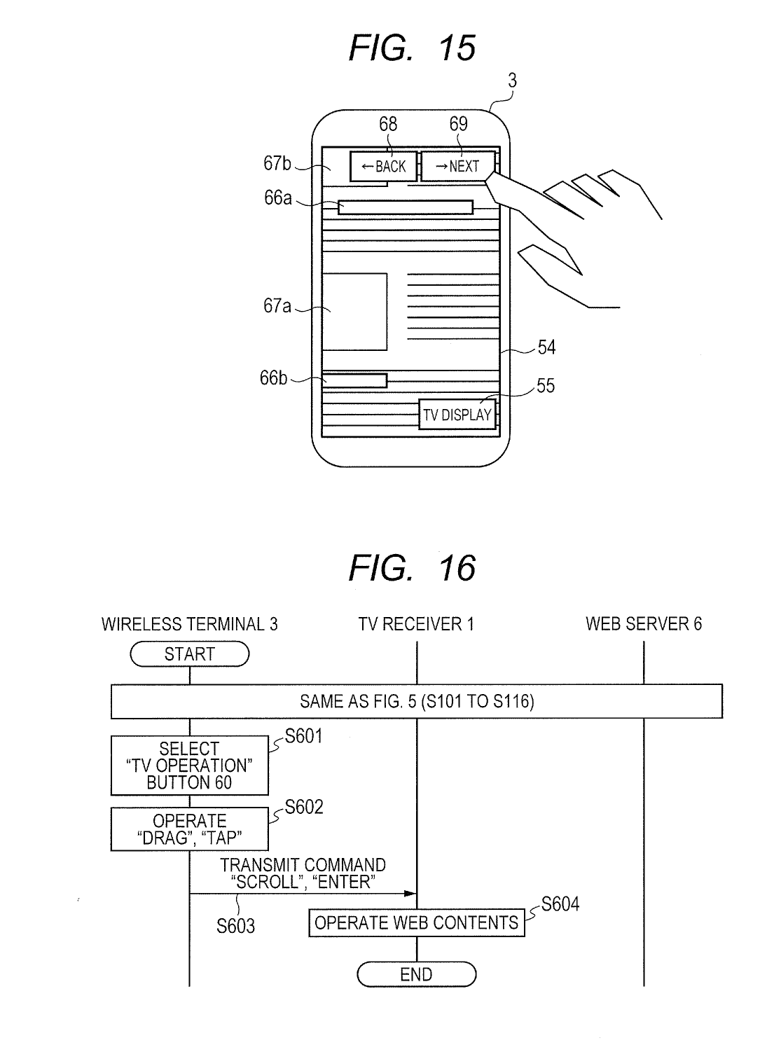

FIG. 15 illustrates the display screen and operation of the wireless terminal 3 according to the fifth embodiment. The display screen of the wireless terminal 3 displays the Web contents. As described above, in response to the user's operation of the “TV display” button 55, the same Web contents are displayed on the display unit 20 of the TV receiver 1. Operation of the anchor texts 66a, 66b or the anchor objects 67a, 67b allows transition to the linked screen based on the URL of the linked information.

The embodiment includes a “back” button 68 and a “next” button 69 as the history function. The “back” button 68 is operated to move the previously accessed (or browsed) Web page to 1 lower level. The “next” button 69 is operated to move the previously accessed (or browsed) Web page to 1 higher level. The Web URL of the previously accessed page is stored in the memory 33 as the display history to form the tree-like hierarchy. The Web page may be moved to the lower or higher level by operating the “back” button 68 or the “next” button 69.

The operation that returns the state where a certain Web page is displayed to 1 lower level will be described. In response to tapping of the “back” button 68 on the wireless terminal 3, the browser engine 3101 reads the URL of the linked information at the 1 lower level from the display history data stored in the memory 33, and displays the Web contents screen at the link on the display unit 38. Furthermore, the browser engine 3101 passes the URL of the linked information at the 1 lower level to the browser engine 2101 of the TV receiver 1 via the communication I/F 39, the wireless router 4, the communication I/F 22, and the control unit 24. As a result, the display unit 20 of the TV receiver 1 is capable of displaying the Web contents screen at the 1 lower level.

This embodiment has been described, taking the “history” function that includes the operation of “back” and “next” of the tree hierarchy of the browser as an example. Another example of the “history” function includes the list display function that automatically stores information data of URLs of the browsed page and the browsed data, and displays the list of data in accordance with a certain criteria. In this case, the displayed list of the linked information corresponds to the display history. As the similar function as described above, the “bookmark” function may be provided, which determines whether or not the user is likely to browse the previously accessed page again, and stores the page information as the bookmark information. The information will be displayed in the hierarchy. In this case, the linked information displayed in the hierarchy corresponds to the display history.

The fifth embodiment is capable of displaying the display history of the Web contents displayed on the wireless terminal, and the stored bookmarked Web page and contents on the TV receiver with ease.

### Sixth Embodiment

A sixth embodiment according to the present invention will be described. The sixth embodiment has an additional function that allows the wireless terminal to operate the screen of the TV receiver.

### <System Structure>

The network terminal system according to the sixth embodiment is similar to the first embodiment (FIG. 1) as well as the inner structure of the TV receiver 1 and the wireless terminal 3 (FIGS. 2A and 2B), explanation of which will be omitted. The wireless terminal 3 of the embodiment includes the function of operating the display screen of the Web contents on the TV receiver 1 by operation using the input unit 41.

### <Software Structure>

The software structure of the sixth embodiment is similar to the first embodiment (FIGS. 3A and 3B), explanation of which will be omitted.

### <Operating Sequence>

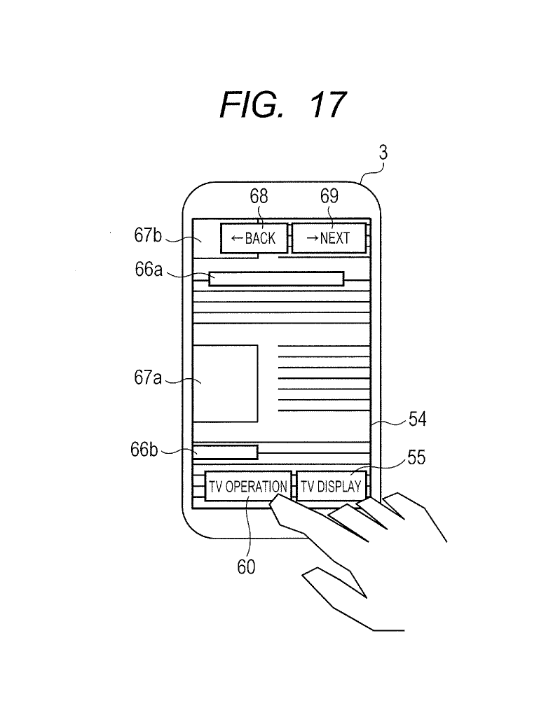

FIG. 16 shows the operating sequence of the sixth embodiment. FIG. 17 illustrates the display screen and operation of the wireless terminal 3. The wireless terminal includes the “TV operation” button 60 for operating the display screen of the Web contents on the TV receiver 1. In this embodiment, process steps of S601 to S604 are newly added to the sequence (S101 to S116) of the first embodiment (FIG. 5).

As a result of the sequence (S101 to S116), the display unit 20 of the TV receiver 1 displays the same Web contents as those displayed on the wireless terminal 3.

S601: Referring to the display screen of the wireless terminal 3 as shown in FIG. 17, the “TV operation” button 60 is tapped with the finger.

S602: The specific operation of the “TV operation” will be performed on the display screen of the wireless terminal 3 by “dragging” and “tapping”. Those operations are converted into the operation commands to the display unit 20 of the TV receiver 1 by the control unit 37. For example, scroll of the screen through the “dragging” or “flicking” operation may be converted into the “scroll” command or “pointer” command, and the “tapping” operation may be converted into the “enter” command.

S603: The control unit 37 transmits the operation commands such as the “scroll” and “enter” to the control unit 24 of the TV receiver 1 via the communication I/F 39, the wireless router 4, and the communication I/F 22.

S604: The control unit 24 of the TV receiver 1 controls the browser engine 2101 in accordance with the received operation command, and operates the display screen of the Web contents displayed on the display unit 20.

In this way, the sixth embodiment allows the wireless terminal to easily operate the display screen of the TV receiver.

The operation of this embodiment will be described complementarily. The display screen of Web contents on the display unit 38 of the TV receiver 1 will be scaled up or down by “pinch in” or “pinch out” operation performed on the display screen (touch panel) of the wireless terminal 3 as FIG. 6C shows. The aforementioned operation may be transmitted as the operation command in accordance with the change in the distance between two points defined by two fingers. The “scroll” operation may be transmitted as the command in accordance with the moving direction or moving distance of the finger. Upon reception of those commands, the control unit 24 of the TV receiver 1 functions to scale down the Web contents, for example, in accordance with the amount of change and the moving speed in response to the “pinch in”, that is, the operation directed to reduce the distance between the two points.

In this embodiment, the “TV display” button 55 and the “TV operation” button 60 are provided separately. However, the “TV display” button 55 may serve as the “TV operation” button. In this case, the TV receiver 1 may be operated in association with tapping of the “TV display” button 55. After operating the “TV display” button 55 or the “TV operation” button 60, display of those buttons may be changed into the “terminal display” button or the “terminal operation” button so as to be used as the button for displaying the screen or returning the operation of the wireless terminal 3.

In the case where the Web contents screen of the TV receiver 1 is operated by the display unit 38 of the wireless terminal 3, the wireless terminal 3 may be configured to display only the operation button such as the “TV operation” button 60 without displaying the Web contents in order to avoid operational errors.

This embodiment describes the method of selecting the button on the screen of the display unit 38 of the wireless terminal 3 as the means of selecting operation of the Web contents displayed on the wireless terminal 3 or the TV receiver 1. A modified example may be configured to automatically control operation of the TV receiver 1 upon its transition to the link by the URL of the linked information. The linked information includes the URL of the contents such as the object, image file, and the video file, and the address information of the contents stored in the storage 26 or 34.

According to the sixth embodiment, when displaying the Web contents displayed on the wireless terminal on the TV receiver for transition of the screen to the link by the URL of the linked information, the Web contents on the TV screen may be operated by the wireless terminal.

### Seventh Embodiment

A seventh embodiment according to the present invention will be described. The seventh embodiment includes an additional function of inputting a search character to the Web contents screen of the TV receiver by operating the wireless terminal.

### <System Structure>

The network terminal system according to the seventh embodiment is similar to the first embodiment (FIG. 1) as well as inner structures of the TV receiver 1 and the wireless terminal 3 (FIGS. 2A and 2B), explanations of which will be omitted.

### <Software Structure>

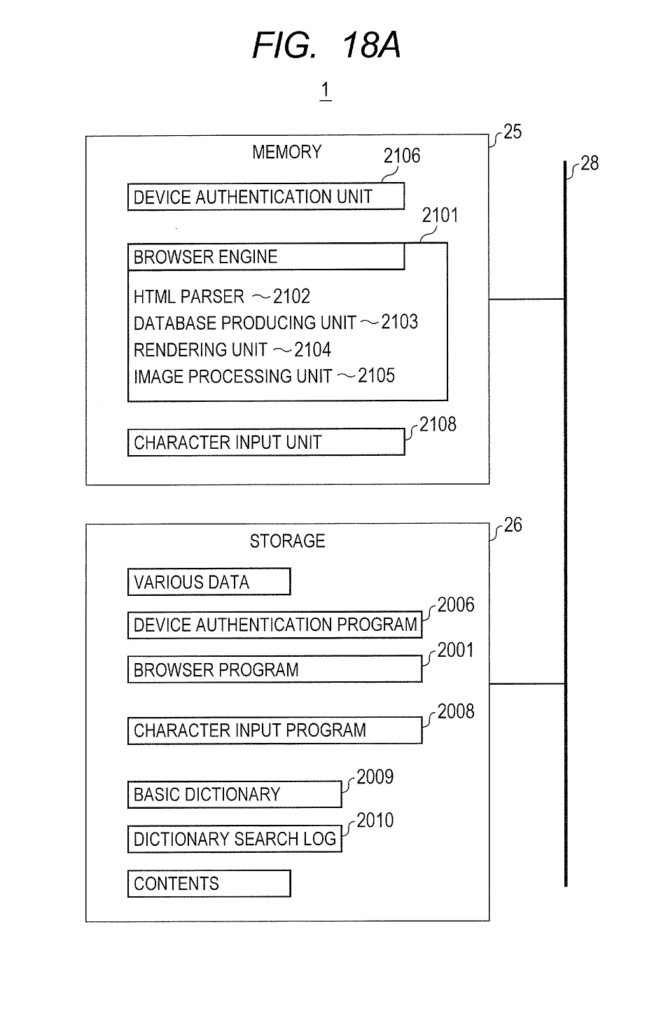

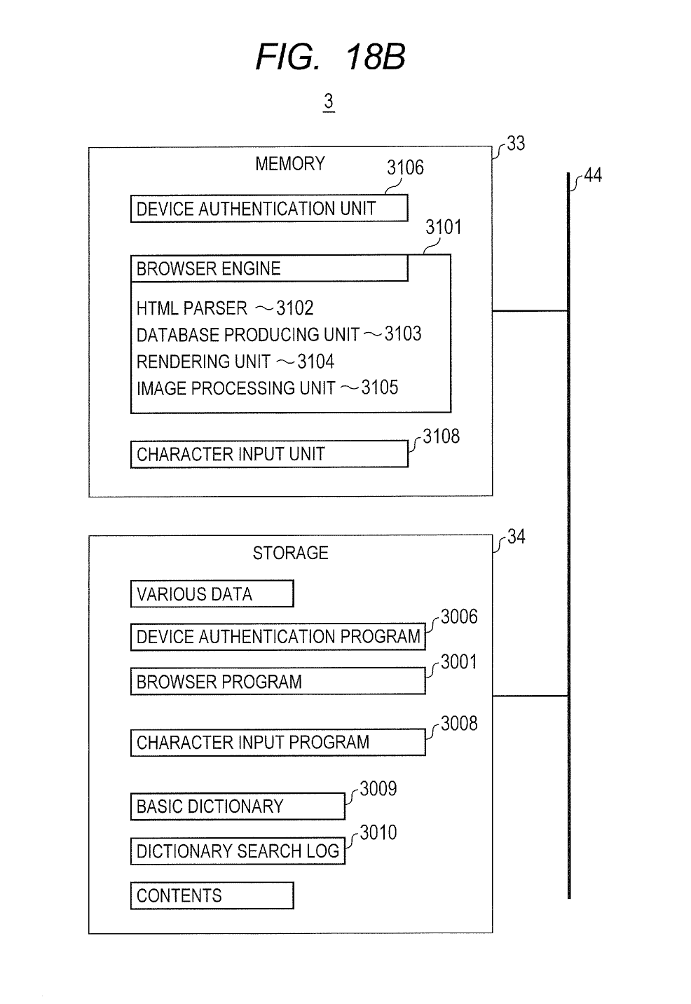

FIG. 18A shows structures of the memory 25 and the storage 26 within the TV receiver 1. FIG. 18B shows structures of the memory 33 and the storage 34 within the wireless terminal 3. Differences between the structures of this embodiment and those described in the first embodiment (FIGS. 3A and 3B) will be described.

The storage 26 (34) includes an additional character input program 2008 (3008). The memory 25 (33) includes an additional character input unit 2108 (3108) derived from loading the character input program 2008 (3008). Storage and obtaining of the character input program 2008 (3008) are performed in the similar way to the other program as described in the first embodiment.

The storage 26 (34) stores a basic dictionary 2009 (3009) and a dictionary search log 2010 (3010). The basic dictionary 2009 (3009) includes a dictionary function of displaying predictive conversion candidates with respect to the input characters. The conversion candidates are extracted in accordance with priority, and displayed on the predictive conversion candidate display unit. The priority is preliminarily stored in the basic dictionary 2009 (3009) for each term. The dictionary search log 2010 (3010) stores the history of past input characters. When the characters are input, the predictive conversion candidates are displayed in accordance with priority of the history data.

The search candidate list information derived from the search site is used preferentially rather than the basic dictionary 2009 (3009) and the dictionary search log 2010 (3010). If there are no search candidate lists, data of the basic dictionary 2009 (3009) or the dictionary search log 2010 (3010) will be used.

Upon user's operation through the input unit 23 and reception of the character string through the software keyboard displayed on the display unit 20 or the physical button, the character input unit 2108 of the TV receiver 1 passes the character string information to the browser engine 2101 as the search condition. When inputting characters using the wireless terminal 3, the unit transmits the input form such as the number of input characters and lines of the input character string, attribute information such as effective letter type, and the search candidate list information from the search site to the wireless terminal 3. Then the wireless terminal 3 determines with respect to effectiveness of inputting characters from the user so that the TV receiver 1 receives the effective character string data.

When the software keyboard is displayed on the display unit 20 in response to the user's operation through the input unit 23 of the TV receiver 1, the character input unit 3108 of the wireless terminal 3 is activated in association with the TV receiver 1 to enable input of the character from the input unit 41 of the wireless terminal 3.

### <Operating Sequence>

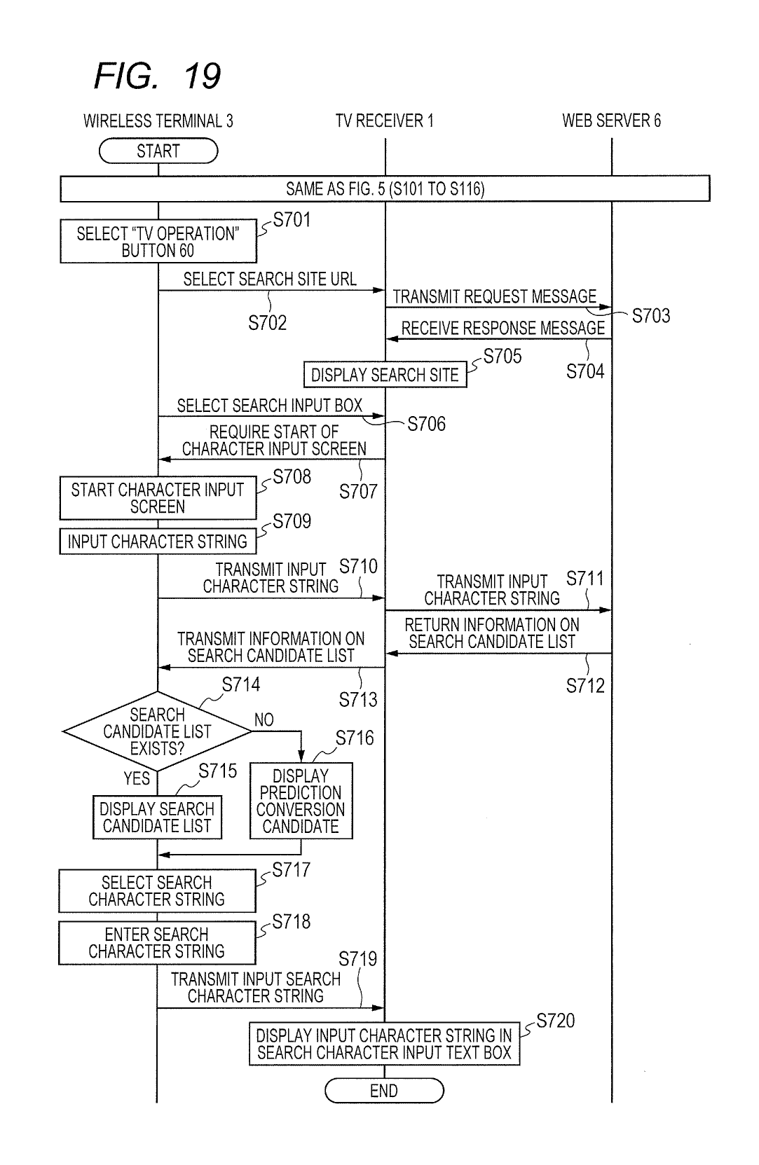

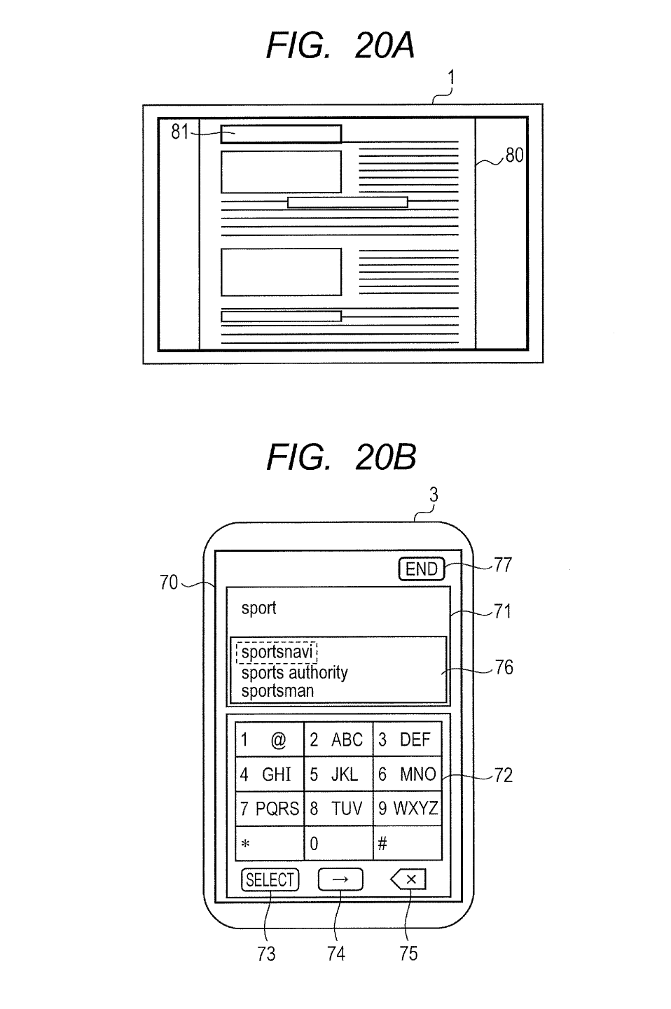

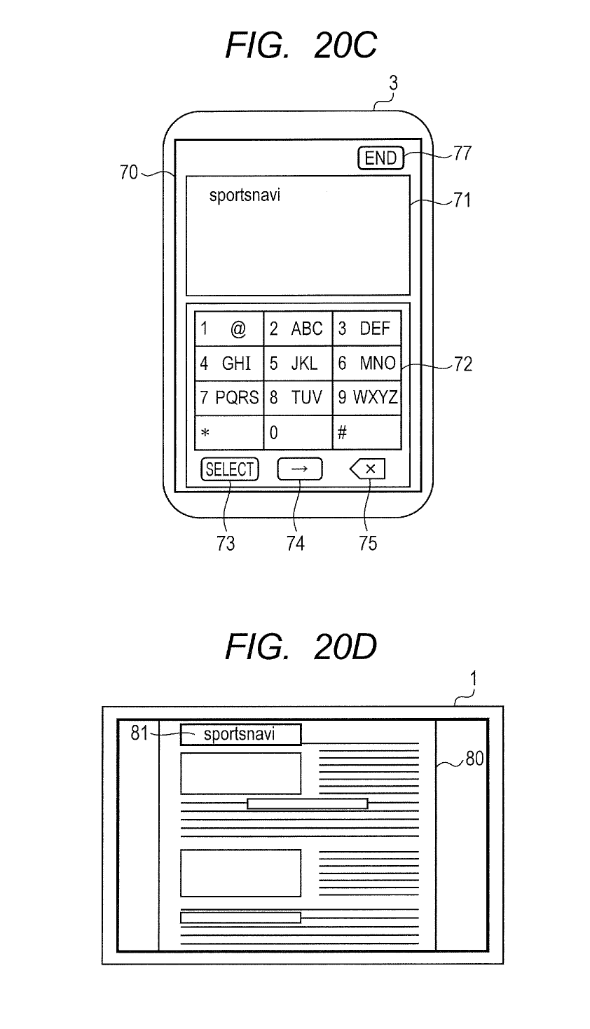

FIG. 19 shows the operating sequence according to the seventh embodiment, representing the input of the search character string through operation of the input unit 41 of the wireless terminal 3 upon keyword searching from the search site of the Web contents by the TV receiver 1. FIGS. 20A and 20D illustrate display screens of the TV receiver 1. FIGS. 20B and 20C illustrate the display screens and operations of the wireless terminal 3. In this embodiment, process steps S701 to S720 are newly added to the sequence (S101 to S116) of the first embodiment (FIG. 5).

As a result of the sequence (S101 to S116), the display unit 20 of the TV receiver 1 displays the same Web contents as those displayed on the wireless terminal 3.

S701: The “TV operation” button 60 on the display screen of the wireless terminal 3 is selected for operating the Web contents display screen of the TV receiver 1 (see FIG. 17).

S702: Then the URL of the search site is selected through the input unit 41 of the wireless terminal 3.

S703: The browser engine 2101 of the TV receiver 1 transmits the request message requiring the resource such as the Web contents in accordance with HTTP to the server 6 designated with the URL of the search site on the network via the external network 5.

S704: The server 6 designated with the URL produces the response message corresponding to the received request message, and returns the message. The returned response message is input to the browser engine 2101 of the TV receiver 1 via the external network 5.

S705: The response message has the HTML document embedded therein. The browser engine 2101 of the TV receiver 1 generates the browser display screen, and displays the Web contents of the search site on the display unit 20. FIG. 20A shows Web contents 80 of the search site and a search character input text box 81, which are displayed on the display unit 20 of the TV receiver 1.

S706: The search character input text box 81 of the search site screen displayed on the TV receiver 1 is selected by tapping operation to the input unit 41 of the wireless terminal 3.

S707: The control unit 24 of the TV receiver 1 instructs the character input unit 3108 of the wireless terminal 3 to activate the software keyboard.

S708: The character input unit 3108 of the wireless terminal 3 displays the character input screen on the display unit 38. FIG. 20B illustrates the display screen of the wireless terminal 3, and a character input screen 70.

S709: The user inputs desired character string to the character input screen 70 through the input unit 41. Numeric keys 72 may be used to input the desired character string to a character input area 71 in the screen. The embodiment provides the software keyboard for “input of English character” with “numeric format”. However, use of a “select” button 73 may select the letter type among “Hiragana character”, “Katakana character”, and “numeric character”. Alternatively, it may be selected to the “numerical format” or “QWERTY layout format”, which is not shown. Use of a “right arrow” button 74 allows the cursor to move rightward by tapping when inputting the character allocated to the same button in the numerical format. Use of a “delete” button 75 is capable of deleting the last input character by tapping. FIG. 20B illustrates the example of inputting the character string “sport” in the character input area 71.

S710: The character string input (or in the middle of inputting) in the character input area 71 on the wireless terminal 3 are transmitted to the control unit 24 of the TV receiver via the communication I/F 39.

S711: The control unit 24 of the TV receiver 1 instructs the browser engine 2101 to transmit the received character string to the search site.

S712: The server 6 of the search site returns the search candidate list information relevant to the received character string to the browser engine 2101 of the TV receiver 1.

S713: The control unit 24 of the TV receiver 1 transmits the search candidate list information received by the browser engine 2101 to the control unit 37 via the communication I/F 39 of the wireless terminal 3.

S714: If there is the search candidate list information (S714: YES), the control unit 37 of the wireless terminal 3 proceeds to process step S715. If there is no search candidate list information (S714: NO), the unit proceeds to process step S716.

S715: The wireless terminal 3 displays the received search candidate list to a search candidate list display area 76 in the character input area 71.

S716: If there is no search candidate list information, the conversion candidate is predicted using the basic dictionary 3009 and the dictionary search log 3010 so that the predictive conversion candidate is displayed on the search candidate list display area 76. Referring to the example of FIG. 20B, the search candidate list display area 76 displays the candidates for the input character string “sport”, for example, “sportsnavi”, “sports authority”, “sportsman” and the like.

S717: The user operates the input unit 41 to select the desired character string from the search candidate list. For example, the “sportsnavi” is selected from the search candidate list by tapping. FIG. 20C illustrates the selected character string “sportsnavi” displayed in the character input area 71 on the display screen of the wireless terminal 3.

S718: The character string selected by the user is entered as the input of the search character. When selecting an “end” button 77 on the display screen shown in FIG. 20C, the character string “sportsnavi” in the character input area 71 is entered as the search character input.

S719: The search character string “sportsnavi” in the character input area 71 is transmitted to the TV receiver 1 from the wireless terminal 3.

S720: The search character string transmitted from the wireless terminal 3 is displayed on the display unit 20 of the TV receiver 1. Referring to FIG. 20D, the search character string “sportsnavi” transmitted from the wireless terminal 3 is displayed in the search character input text box 81 on the display screen of the TV receiver 1. The character string input to the display screen of the TV receiver 1 shown in FIG. 20A by the wireless terminal 3 is input to the search character input text box 81 in the Web contents 80 as the search characters as FIG. 20D shows.

The aforementioned sequence is capable of turning the search candidate function OFF. In such a case, the process steps from S711 to S719 are skipped so as not to display the screen shown in FIG. 20B.

The seventh embodiment allows to input the characters by the wireless terminal easily, when displaying the Web contents displayed on the wireless terminal on the TV receiver and inputting the search characters to the Web contents onto the TV screen.

The respective embodiments according to the present invention have been described. It is to be understood that the present invention is not limited to the embodiments as described above, but includes various modified embodiments. Specifically, the embodiments have been described with respect to the entire system in detail for the purpose of easy understanding of the present invention. Accordingly, the present invention is not limited to the one provided with all the structures as have been described so far. It is also possible to replace a part of the structure of one of the embodiments with the structure of the other embodiment. Alternatively, the structure of the embodiment may be additionally provided with the structure of the other embodiment. The structure of each of the embodiments may have the structure of the other embodiment partially added, deleted, and replaced.

The respective structures, functions, processing parts and processing units may be partially or entirely realized by hardware through designing with the integrated circuit. The respective structures, functions and the like may also be partially or entirely realized by software by interpreting the program for realizing the respective functions, and executing the program. The information for realizing the respective functions such as the program, table and file may be provided in the storage device, for example, memory, hard disk and SSD (Solid state drive), or the recording medium such as the IC card, SD card and DVD.

The program described in the respective processing examples may be formed as the independent program, or the single application program formed of a plurality of programs. The control lines and information lines are provided as they are required for explanation. All the control lines and information lines are not necessarily illustrated. It may be considered that substantially all the structures are mutually connected with one another.

What is claimed is:

1. A network terminal system that allows a wireless terminal and a display device, which are connected via a network to obtain contents from a server via an external network, wherein:
the wireless terminal includes a first information obtaining unit that obtains first contents, an identifier that contains information indicating a server for supplying the first contents and information for identifying the first contents, and session information for uniquely identifying a user of the wireless terminal, from the external network, and a first transmitter/receiver unit which transmits the identifier and the session information obtained by the first information obtaining unit to the display device; and
the display device includes a second transmitter/receiver unit that receives the identifier and the session information transmitted from the wireless terminal, a second information obtaining unit that obtains the first contents and the session information correlated with the first contents from the server indicated by the identifier received by the second transmitter/receiver unit, and a second display unit that displays the first contents obtained by the second information obtaining unit.

2. The network terminal system according to claim 1, wherein:
the wireless terminal includes a first display unit that displays the first contents obtained by the first information obtaining unit; and
the first transmitter/receiver unit transmits the identifier of the first contents and the session information, which are displayed by the first display unit to the display device.

3. The network terminal system according to claim 2, wherein:
the wireless terminal includes a position information obtaining unit that obtains position information indicating a display area of the first contents displayed on the first display unit;
the first transmitter/receiver unit transmits the position information together with the identifier to the display device; and
when displaying the first contents obtained by the second information obtaining unit, the second display unit of the display device displays the contents in the display area indicated by the position information in a range of the display area of the second display unit.

4. The network terminal system according to claim 1, wherein:
the wireless terminal includes a first device authentication unit that produces authentication information to transmit to the display device;
the display device includes a second device authentication unit that authenticates the wireless terminal based on the received authentication information; and
upon success of authentication by the second device authentication unit, the second transmitter/receiver unit receives the identifier and the session information.

5. The network terminal system according to claim 1, wherein the identifier contains a URL, and the session information contains a session ID and a session variable.

6. A wireless terminal that constitutes a network terminal system capable of obtaining contents from a server via an external network, comprising:
a first information obtaining unit that obtains first contents, an identifier which contains information indicating a server for supplying the first contents and information for identifying the first contents, and session information for uniquely identifying a user of the wireless terminal, from the external network;
a first display unit that displays the first contents obtained by the first information obtaining unit; and
a first transmitter/receiver unit that transmits the identifier and the session information obtained by the first information obtaining unit to a display device that constitutes the network terminal system so as to be allowed to display the first contents obtained from the server.

7. The wireless terminal according to claim 6, further comprising an input operation unit that selects an identifier of second contents contained in the first contents,
wherein the first transmitter/receiver unit transmits the identifier of the second contents selected by the input operation unit to the display device.

8. The wireless terminal according to claim 6 further comprising a display history storage unit that stores the identifier of the contents displayed on the first display unit as a display history,
wherein the first transmitter/receiver unit transmits the identifier stored in the display history storage unit to the display device.

9. The wireless terminal according to claim 6, further comprising an input operation unit that receives a display operation of the first contents displayed on the first display unit,
wherein the first transmitter/receiver unit of the wireless terminal transmits operation information produced based on a display operation received by the input operation unit to the display device, for a display operation of the first contents on a second display unit of the display device.

10. The wireless terminal according to claim 6, further comprising a character input unit that receives an input of a character to the first contents displayed on the first display unit,
wherein the first transmitter/receiver unit of the wireless terminal transmits character input information received by the character input unit to the display device, for a character input operation to the first contents on a second display unit of the display device.

11. A contents display method of displaying contents obtained by a wireless terminal and a display device which are connected with a network from a server via an external network, comprising the steps of:
the wireless terminal obtaining an identifier that contains information indicating a server for supplying first contents and information for identifying the first contents, and session information for uniquely identifying a user of the wireless terminal, from the external network;
the wireless terminal transmitting the obtained identifier and the session information to the display device;
the display device receiving the identifier and the session information transmitted from the wireless terminal;
the display device obtaining the first contents and the session information correlated with the first contents from the server indicated by the received identifier via the external network; and
the display device displaying the obtained first contents on a display unit of the display device.
